(19) United States
(12) Patent Application Publication
(10) Pub. No.: US 2015/0109323 A1
(43) Pub. Date: Apr. 23, 2015

(54) INTERACTIVE BLACK AND WHITE IMAGE EDITING

(71) Applicant: Apple Inc., Cupertino, CA (US)

(72) Inventors: Garrett M. Johnson, San Francisco, CA (US); Russell Y. Webb, San Jose, CA (US)

(73) Assignee: Apple Inc., Cupertino, CA (US)

(21) Appl. No.: 14/058,093

(22) Filed: Oct. 18, 2013

(51) Int. Cl. G06T 11/00; G06F 3/0484; G06T 5/00; G09G 5/02

(52) U.S. Cl. CPC G06T 11/001; G09G 5/02; G06F 3/04847; G06T 5/005; G06T 2200/24; G09G 2354/00; G09G 2340/06; G06T 2207/10024
USPC 345/594

(57) ABSTRACT

A method for generating and/or modifying a grayscale image. The method receives a color image. The method generates an initial grayscale image based on attributes of the color image. The method generates a set of hue values for all the pixels in the grayscale image based on color values of the pixels in the color image. The method defines a hue curve across the range of hue values based on input received from a user interface control. The method modifies the grayscale image based on the hue values and the defined hue curve across the range of hue values.

### BACKGROUND

Digital images can be color (e.g., made up of red, green, and blue components) or black and white (e.g., grayscale). Many image editing applications have the ability to convert color images to black and white (grayscale) images. However, after a grayscale image is generated, a user is limited in the tools available for further enhancing the grayscale image based on the original color attributes of the image. In particular, these color attributes are essentially lost in the grayscale image since the various color pixels are transformed only to different shades of gray. This makes it difficult for a user to apply, for example, certain gray scale enhancements to only areas of the image that were of a particular color within the color image. For example, a user is unable to lighten or darken only those areas in the grayscale image that were blue (or yellow, red, green, etc.) within the original image. Furthermore, in order to provide an appealing enhanced image, when a user lightens (or darkens) certain shades of gray within the grayscale image that correspond to a particular color within the color image, the tool should automatically darken other shades of gray that correspond to a different color in the color image to enhance the contrast and produce an appealing grayscale image. Therefore, there is a need in the art for an image editing application that allows a user to apply, using simple controls, enhancements to a grayscale image using the color attributes of the color image.

### BRIEF SUMMARY

Some embodiments described herein provide an image editing application that provides novel controls for enhancing a grayscale image based on color attributes of an original color image. The novel controls may include any one of a modifiable curve, various adjustable sliders, and various on-screen controls. These controls provide the user with the ability to enhance a grayscale image according to their preferences. In particular, these controls allow the user to lighten (or darken) the shades of gray within the grayscale image that share the same (or similar) color attributes within the original color image. For example, a user may lighten (or darken) the shade of gray of only those pixels in the grayscale image that appear as blue (or red, green, yellow, etc.) within the original color image. Likewise, a user may easily specify different modifications for each color value across the entire range of colors in the color spectrum using the modifiable curve to define how different grayscale pixels should be modified.

In some embodiments, the modifiable curve spans across the entire range of hue color values (e.g., hue color circle ranging from blue, green, orange, yellow, and back to blue). The shape of the hue curve determines the amounts (i.e., gamma values) by which the pixels in the grayscale image are either lightened or darkened. For example, the user can select a point along the hue curve and drag upwards the portion of the curve that lies primarily over blue hue values to lighten the shade of gray of pixels in the grayscale image that have hue values within the blue range of the hue vales. Likewise, the user can select and drag down a portion of the hue curve that lies primarily over the orange and red hue values to darken the shades of gray of pixels in the grayscale image that were originally red or orange in the color image.

The user can utilize a variety of controls for modifying the particular shape of the hue curve across the range of hue color values, including controls that adjust an amplitude (peak or trough) of a function (e.g., a sine wave) imposed on the curve and the phase of such a function (the particular position of the peak and trough of the function with respect to the hue range). In some embodiments, the controls provide the user with the ability to directly modify the hue curve (e.g., through selecting and dragging the curve in different directions or through different touch gestural input). In some embodiments, the hue curve is adjusted using a variety of slider controls that modify the amplitude and/or the phase of a function imposed on the hue curve. In some embodiments, the image editing application provides various on screen controls that allow a user to directly select (or touch) different areas of the image in order to apply the grayscale enhancements. In some embodiments, the hue curve is not visible within the user interface of image editing application. However, the image editing application may still compute values in a background process based on a hue curve in order to modify the grayscale image.

In some embodiments, the user interface of the image editing application provides two particular slider controls for manipulating the shape of the hue curve. A first slider control modifies the amplitude (or strength) of the curve across the hue color spectrum. A second slider control modifies the phase of the curve across the hue color spectrum. In some embodiments, the curve is computed as a sine wave across the hue color range. The amplitude of the sine wave determines the amount (i.e., gamma value) by which a particular grayscale pixel at a particular hue value will be modified (either lightened or darkened). The phase of the sine wave may also be adjusted such that the sine wave traverses across the hue color range, providing different grayscale images based on the particular position of the curve over the range of hue color values. In some embodiments, the image editing application may define the curve according to a different type of curve other than a sine wave (e.g., cosine wave, triangular function, parameterized curve, etc.). Furthermore, in some embodiments, the hue curve may be used to modify the contrast of different pixels in a color image (rather than a grayscale image). In particular, the hue curve may be applied to increase or decrease the contrast of pixels in the color image based on the pixel's hue values. Although the figures described below primarily discuss enhancements to a grayscale image, these same enhancements may be applied to a color image, including application of a curve across a range of hue values that determines contrast values for different pixels in the color image.

In some embodiments, the curve is a deformable parameterized curve that may be modified using control points. For example, in some embodiments, the curves are formed by a set of Bezier curves interconnecting the control points. Additionally, the control points may include modifiable tangent lines for further control over the shape of the curve. In some embodiments, the curves may be adjusted through the use of a Gaussian distribution, or Gaussian “bumps”, that modify the shape of the curve. A user may control the distribution of the Gaussian, such as the height of the Gaussian peak (i.e., amplitude) and width of the Gaussian bump. In some embodiments, the user may only control the amplitude of the Gaussian bump while the width (or distribution) is a fixed constant. By distributing the Gaussian bump over a set range of hue color values, the image editing application is able to produce smooth and blended grayscale enhancements while minimizing the amount of artifacts within the image.

In order to determine how each pixel in the grayscale image (or color image) is to be modified based on the shape of the hue curve across the range of hue values, the image editing application computes a hue value for each grayscale pixel based on the pixel's original color values (i.e., RGB) in the color image. A grayscale pixel's hue value determines the hue angle of the pixel with respect to the hue color wheel. Different angles of the hue color wheel correspond to different colors, ranging from different shades of blues to greens to yellows to oranges and back to blues. Different ranges of hue values may be used to define values in the hue color range wheel. For example, in some embodiments, the hue values can range from [0-1] or [0-360 degrees] corresponding to different angles within the hue color wheel.

The hue value is computed based on the original color values (i.e., RGB values) of the pixel in the color image. The image editing application uses both the hue values of the pixels within the grayscale image and the corresponding shape of the hue curve across the range of hue color values in order to compute different gamma values to apply to the grayscale pixels. Each particular gamma value for a pixel determines the amount by which the shade of gray of the particular pixel is to be lightened or darkened. In some embodiments, the gamma value is an exponent that is applied to each particular grayscale pixel. Each pixel in the image is modified according to the computed gamma value for the particular pixel's hue value. By adjusting all of the pixels in the image according to their particular gamma values, the image editing application is able to generate the final enhanced black and white (grayscale) image.

The preceding Summary is intended to serve as a brief introduction to some embodiments described herein. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matters are not to be limited by the illustrative details in the Summary, Detailed Description and the Drawings, but rather are to be defined by the appended claims, because the claimed subject matters can be embodied in other specific forms without departing from the spirit of the subject matters.

### BRIEF DESCRIPTION OF THE DRAWINGS

The novel features of the invention are set forth in the appended claims. However, for purpose of explanation, several embodiments of the invention are set forth in the following figures.

FIG. 1 illustrates an image editing application that includes the novel tools for enhancing a grayscale image based on the attributes of a color image.

FIG. 2 illustrates a process for generating an enhanced grayscale image from a color image.

FIG. 3 illustrates different images that are generated for a color image and used to enhance the grayscale image.

FIG. 4 illustrates the image editing application converting a color image to an initial grayscale image using a three-control, adjustable grayscale converter.

FIG. 5 illustrates the effect of using an “Active 3×1” control when converting a color image to a black and white image.

FIG. 6 illustrates moving a single “phase” slider control to automatically change the color component values for a grayscale conversion of a color image.

FIG. 7 illustrates a process for computing hue values for pixels in a grayscale image based on the color values of the pixels in the color image.

FIG. 8 illustrates a hue control that is displayed in the user interface of some embodiments of the image editing application.

FIG. 9 illustrates a process for determining a shape of a hue curve and computing a gamma value to apply to a particular pixel.

FIG. 10 illustrates a user modifying the amplitude of a function imposed on the hue curve using an adjustable slider tool.

FIG. 11 illustrates a slider control for modifying the phase of a function on the hue curve.

FIG. 12 illustrates adding a Gaussian bump to a hue curve.

FIG. 13 illustrates the image editing application modifying a grayscale image based on on-screen user input.

FIG. 14 illustrates an example of modifying a grayscale image through touch input on a mobile device.

FIG. 15 illustrates the effect of a user touching and dragging downwards on the image display area in order to darken the particular shade of gray of certain areas of the image.

FIG. 16 illustrates that the image editing application in some embodiments displays, in color, the areas of the image that will be modified when the user modifies the hue curve.

FIG. 17 conceptually illustrates part of the software architecture of an image editing application of some embodiments.

FIG. 18 conceptually illustrates a detailed view of a GUI of some embodiments for viewing, editing, and organizing images.

FIG. 19 conceptually illustrates a data structure for an image as stored by the application of some embodiments.

FIG. 20 is an example of architecture of a mobile computing device.

FIG. 21 conceptually illustrates an example of an electronic system with which some embodiments are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide novel controls that allow a user to enhance a black and white (grayscale) image, or color image, based on attributes of the color image. In particular, for a grayscale image, the user may lighten or darken the shades of gray of different pixels of the image based on the color attributes of the pixels within the color image. As a result of the modification, all pixels in the grayscale image that are the same (or similar) colors receive the same modifications within the grayscale image. Thus a user is able to modify different pixels within the grayscale image based on the original color attributes of the pixels in the original color image. For a color image, the user may modify the contrast of the different pixels based on attributes of the original color image. The figures described below primarily discuss enhancements to a grayscale image, however, these same enhancements may be applied to a color image. In particular, the contrast in different regions of a color image may modified using the application of a curve across a range of hue values that determines contrast values for different pixels in the color image.

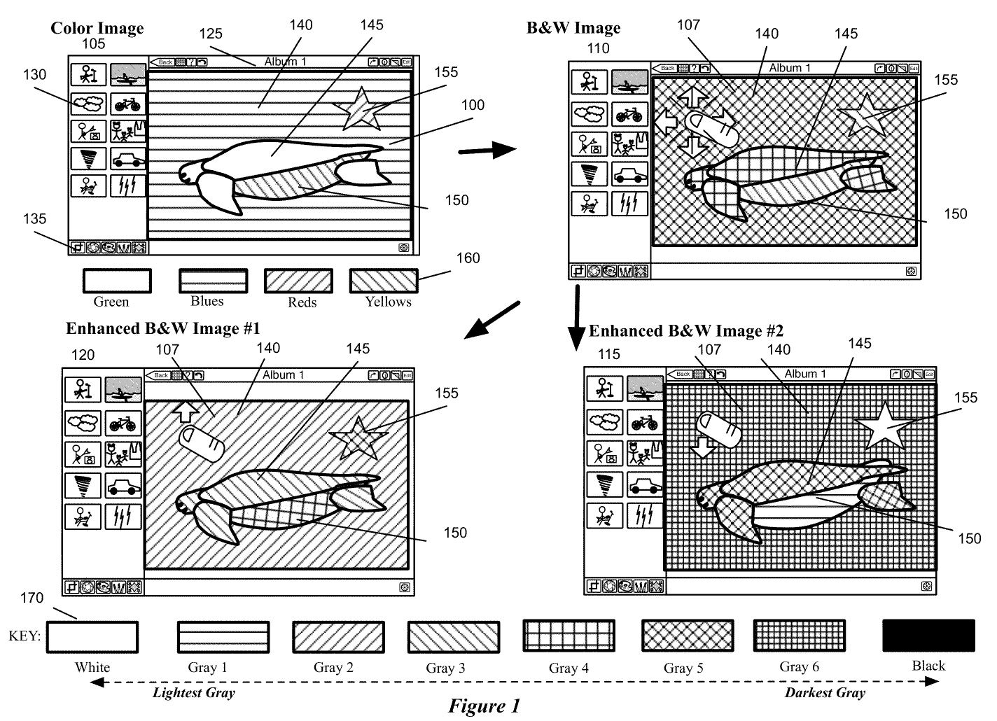

FIG. 1 illustrates an image editing application that includes the novel tools for enhancing a grayscale based on the attributes of the color image 100. In particular, stages 105-120 of FIG. 1 illustrate a user applying grayscale enhancements to a black and white (grayscale) image 107 after it has been converted from a color image 100. Stage 105 illustrates the image editing application executing on a device of the user. The image editing application includes a display area 125, a set of thumbnail images 130, and various image editing tools 135. The display area 125 displays a user-selected image that is selected from the set of thumbnail images 130. In particular, the display area 125 is displaying an image 100 of a turtle that is swimming in water, as well as a starfish located above the turtle. For explanation purposes, the image illustrates only certain colors of the hue color wheel (i.e., blue, green, yellow, and red) confined to uniform areas of the image 100. In a realistic image, many pixels with many different color values will be distributed throughout the image.

The primary colors that appear within the image 100 are the blue water 140, the green shell 145 of the turtle, the yellow underbelly 150 of the turtle, and the red starfish 155. Furthermore, these colors are illustrated using a color key 160, with the blue water 140 indicated by horizontal lines, the green shell 145 of the turtle indicated by white space, the yellow underbelly 150 of the turtle indicated by the diagonal lines going down, and the red starfish 155 indicated by diagonal lines going up (from left to right).

Stage 110 illustrates the image editing application is now displaying the image of the turtle as a black and white (grayscale) image 107, using only different shades of gray to depict the various areas of the image. In particular, at this stage, the user has now selected an option (not shown) to convert the color image 100 to a black and white image 107. As illustrated, different areas of the grayscale image 107 have a different shade of gray (as indicated by the corresponding grayscale key 170), the particular shade of gray used is based on the grayscale conversion that was applied to the color image 100. The grayscale key 170 illustrates several different levels of gray values, ranging from light gray (i.e., gray 1) to dark gray (i.e., gray 6) with the extreme endpoints corresponding to either white or black. For illustrative and explanation purposes, the key only provides a distinct number of different shades of gray (i.e., 1-6). However, the image editing application is able to produce substantially more (e.g., hundred or thousands) of different shading levels of gray that provide a much more subtle and gradual shift between the white and black endpoints. As such, for simplicity of explanation, the figures illustrate different shades of gray either becoming a darker shade or a lighter shade of gray, however the actual grayscale shade may correspond to a different shade of gray throughout the images and is not constant. Thus for example, a level gray 6 in a first figure may correspond to a different level of gray in a different figure. These different grayscale levels are provided in order to illustrate either a darkening (or lightening) effect taking place on a particular set of pixels between different stages of the figures, and thus should not be used to illustrate a mapping to an actual grayscale shading level.

In order to generate the initial grayscale image from the color image, the image editing application applies, in some embodiments, a standard grayscale conversion. Other embodiments may apply different conversion mechanisms. As illustrated in the image 107, the blue water 140 is the darkest shade of gray within the image, (at gray 5), the green shell 145 of the turtle is the next darkest shade of gray (gray 4), while the yellow underbelly 150 (gray 3) and red starfish 155 (gray 3) appear as a lighter shade of gray within the image.

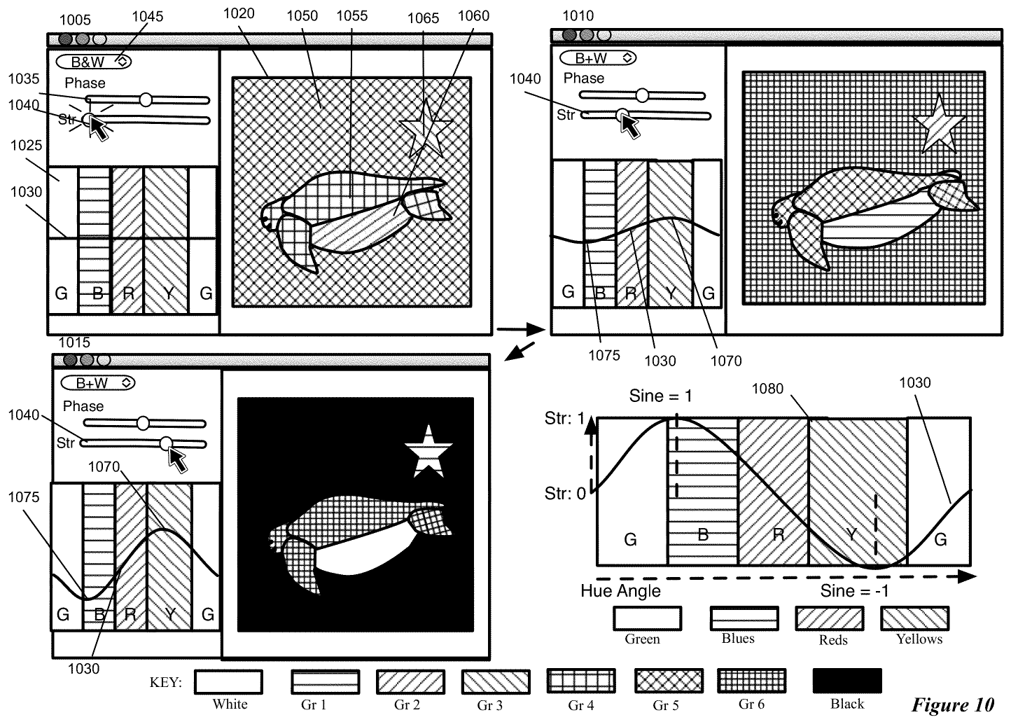

Having obtained this initial gray scale image 107, the user may now apply various controls in order to enhance the shades of gray of the various pixels in the image. In some embodiments, the user may apply on-screen gestures to modify the grayscale image. FIG. 1 illustrates the user applying direct on-screen gestures to modify the grayscale image 107. Other control mechanisms and user interface tools may be used to apply the same or similar modifications. For example, some embodiments provide different adjustable sliders that may be used to lighten or darken certain grayscale pixels of the image. Some embodiments provide a modifiable curve that spans the entire range of hue color values and the user may modify the shape of the curve using sliders and/or direct manipulation of the curve (e.g., selecting and dragging the curve in different directions or modifying control points along the curve). These other types control mechanisms are further described below with reference to FIGS. 10-15.

Stage 110 illustrates the user applying a touching gesture onto the screen of the mobile device in order to apply a grayscale enhancement. In particular, the user is touching the pixels 140 within the grayscale image 107 that correspond to the blue water 140 in the color image. As illustrated, after detecting a touching gesture, the image display area 125 presents four arrows surrounding the area at which the user has touched the image. Each arrow provides an indicator to the user of a different direction that the user may swipe their finger in order to apply a different enhancement (or effect) to the image. In particular, the up and down arrows correspond to the tool for enhancing (i.e., lightening or darkening) the shades of gray of the image, and the left and right arrows correspond to other effects that may be applied to the image. In some embodiments, the left and right arrows apply a “photo-tone” effect to the image. In some embodiments, the directions of the arrows may correspond to different effects.

Stages 115 and 120 illustrate the alternative scenarios from stage 110 of the user either moving their finger down (stage 115) or up (stage 120) on the screen of the device, and the corresponding enhancements that are applied to the grayscale image 107. In particular, stage 115 illustrates the user moving their finger down while selecting the pixels corresponding to the blue water 140 in the image. This causes the image editing application to darken all of the pixels in the image that have the same (or similar) color values as the blue pixels. Thus, all of the blue pixels in the image, which for simplicity in this example are confined to only the pixels in the water, 140, have been darkened to an almost black shade of gray (gray 6). Note that in realistic real-world images, different colors of pixels may be distributes at many different locations in the image.

Likewise, the green pixels in the image, located within the green shell 145, have been slightly darkened as well from a gray level 4 to gray level 5. In particular, the image editing application determined that these pixels have color values (hue values) that were affected based on the modified shape of the hue curve (not displayed) that was computed for the image (i.e., based on the shape of a sine wave across the range of hue color values). In some embodiments, darkening the blue values (and to a lesser extent the green values) also has the effect of lightening pixels that have color values on the opposite end of the hue color range. In particular, the yellow underbelly 150 (at gray 1) and red starfish 155 (at white) now appear as a lighter shade of gray in the image than in stage 110. In some embodiments, when a user commands the application to modify grayscale pixels that have a certain color value, the application only modifies pixels that fall within a particular range of that color value and leaves the remaining pixels unmodified. For example, in some embodiments, the user may darken the shade of gray of the blue pixels and leave the green, yellow, and red pixels unchanged. In these situations, the image editing application in some embodiments computes a Gaussian “bump” to apply to the hue curve. The Gaussian bump generally affects only pixels that lie within a certain range of the selected pixel. The particular modification to the different pixels depends on the shape of the hue curve, as will be further described in detail below in FIGS. 10-12.

Stage 120 illustrates the effect of the user swiping their finger up while selecting the shade of gray pixels corresponding to the blue water 140 in the original color image 100. As illustrated, the pixels corresponding to the blue water 140 and the green turtle shell 145 now appear as a lighter shade of gray than in stage 110. In particular, the water 140 went from a gray 5 to a gray 2 and the green shell 145 went from a gray 4 to a gray 3. Likewise, the pixels corresponding to the yellow underbelly 150 and the red starfish 155 have been darkened from stage 110. In particular, the yellow underbelly 150 darkened from a gray 3 to a gray 4, and the red starfish darkened from a gray 3 to a gray 5.

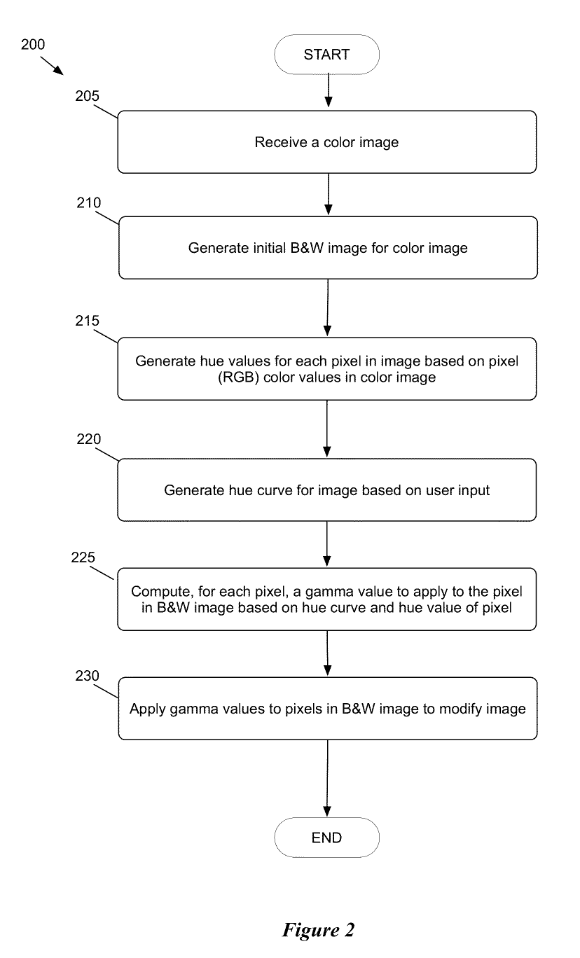

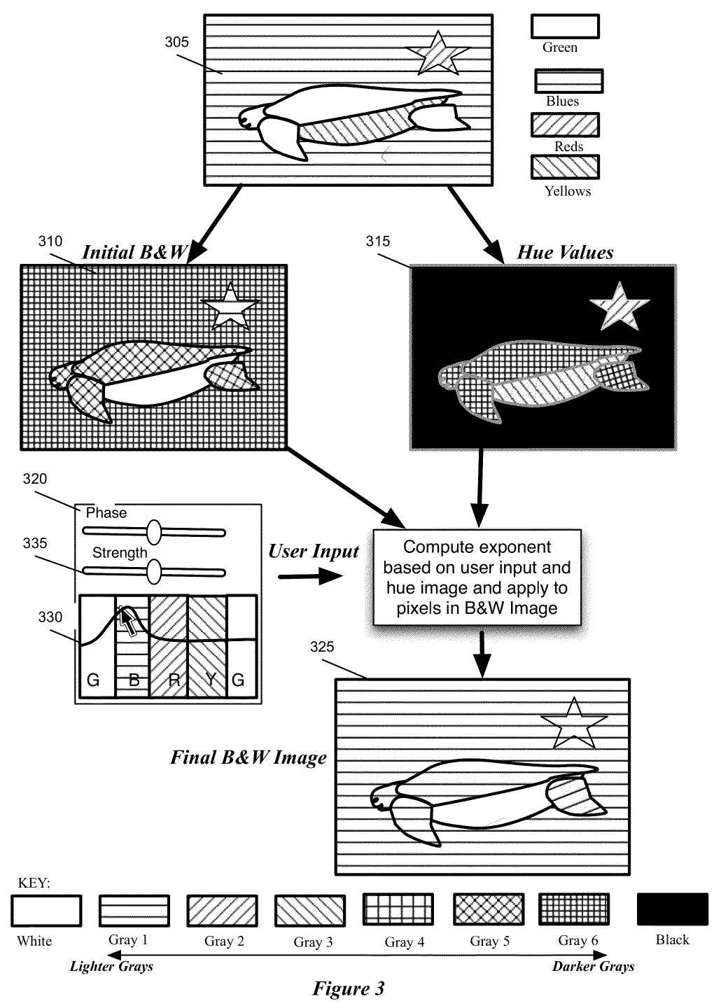

As such, the user is able to enhance different pixels within the grayscale image 107 using the original color attributes of those pixels in the color image 100. Thus the user can lighten areas of an image that have a same (or similar) color by selecting pixels of the grayscale image 107 with that particular color and darken other areas of the image that have a different color by selecting pixels of the image with those colors. Using the various control mechanisms, the user is able to quickly fine-tune the particular shades of gray to use for different grayscale pixels based on their color attributes. FIG. 2 illustrates a process 200 for generating an enhanced grayscale image from a color image. The process 200 illustrated in FIG. 2 will be described by reference to the illustration of FIG. 3. In some embodiments, the specific operations of this process may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

The image editing application initially receives (at 205) a color image. In some embodiments, the pixels of the color image are defined according to an RGB color space. In such a color space, each pixel in the color image contains a red, green, and blue value (RGB) that determines the combined color of the pixel. As illustrated in FIG. 3, the color image 305 is the same image of the turtle described in FIG. 1. In particular, the image contains a turtle with a green shell and yellow underbelly that is swimming in blue water. Furthermore, a red starfish is also above the turtle and is surrounded by the blue water.

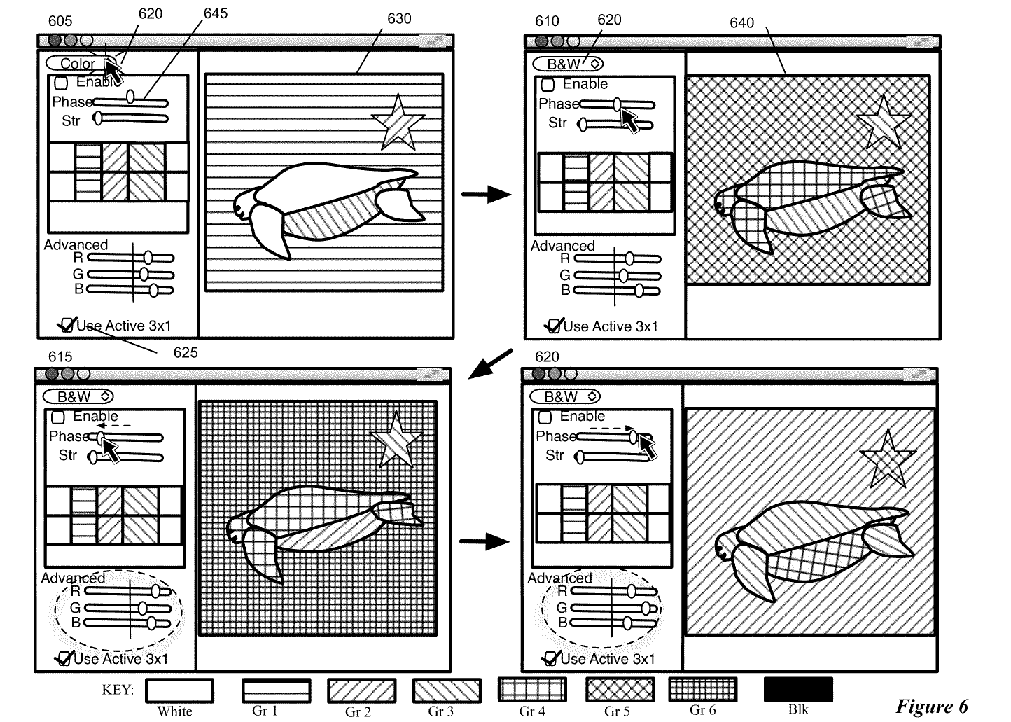

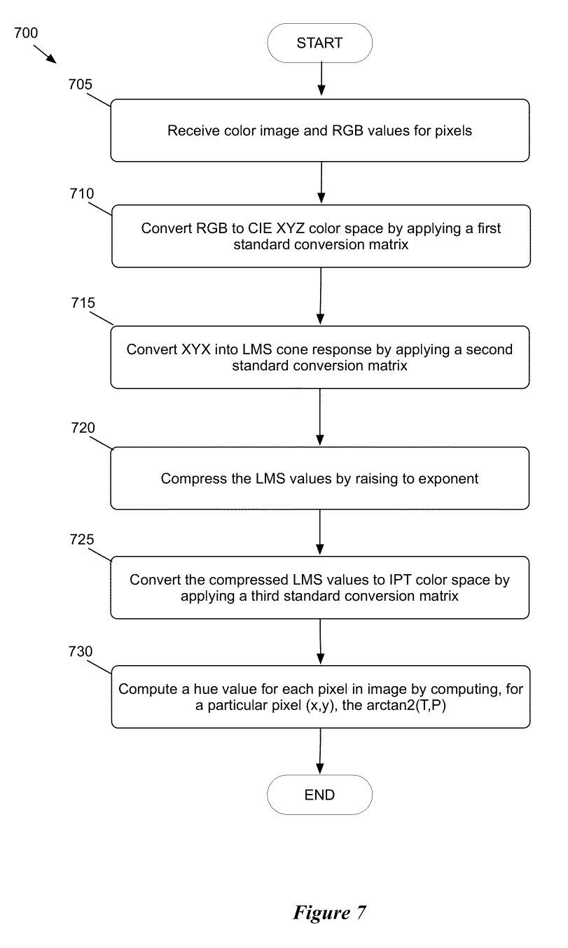

The process 200 next generates (at 210) an initial black and white image for the color image. In order to generate the black and white image, some embodiments apply different weighting values to the R, G, and B color values of the pixels in the color image. In some embodiments, the user may specify the weighting values using an “active 3×1” slider tool, which is described in detail in FIG. 6. As illustrated in FIG. 3, the grayscale image 310 of the turtle illustrates the different shades of gray that have been generated for each of the different color values in the color image 305. In particular, the blues and greens appear as a dark shade of gray while the yellows and reds appear as a lighter gray within the grayscale image 310. In addition to generating a grayscale image 310 from the color image 305, the process 200 also generates (at 215) a corresponding hue mapping of the color image. This hue mapped image 315 provides a computed hue value for each pixel in the grayscale image based on the color values of the pixel in the color image 305. In order to compute the hue values of each pixel, the process 200 applies a series of computations for converting the RGB pixel value of the color pixel into a hue value for the pixel. This series of computations is detailed by reference to FIG. 7, described below.

FIG. 3 illustrates the hue image 315 generated for the color image 305. For illustrative purposes, the hue values are shown as different shades of gray in the image, similar to the grayscale image 310, but these hue values do not necessarily correspond to gray shading values. Having generated a hue mapping for the pixels in the color image 305, the process 200 then defines (at 220) a hue curve across the range of hue color values. The hue curve determines the gamma values that are to be applied to the pixels of the grayscale image in order to produce the enhanced image. The shape of the hue curve may be modified by the user. As illustrated in FIG. 3, the shape of the hue curve 330 determines how much of a modification to apply, in the grayscale image 310, to the different hue values across the range of hue color values. In some embodiments, the user may adjust various sliders 335 within the hue control 320 in order to modify the hue curve 330 (phase and/or strength). Based on the final shape of the hue curve 330, the process 200 computes (at 225), for each pixel in the grayscale image 310, a gamma value to apply to the pixel.

In order to compute the gamma value of a particular pixel, the process determines the hue value of the particular pixel and shape of the hue curve at that particular hue value. This determines how much of a lightening (e.g., applying a gamma value less than 1) or darkening (e.g., applying a gamma value more than 1) effect to apply to the particular grayscale pixel. The process then (at 230) applies the various gamma values to the grayscale pixels of the image which may lighten, darken, or leave unchanged the pixel in the final grayscale image.

As illustrated in FIG. 3, the shape of the hue curve 330 illustrates a Gaussian bump has been applied to the curve. Thus pixels with a hue value in the blue/green range of hue values should receive a lightening of their particular shades of gray, while the remaining pixels should be left unchanged. Thus, the final grayscale image 325 illustrates that the pixels corresponding to the blue water and green turtle shell are now a lighter shade of gray than in the initial black and white image 310. In contrast, the red starfish and yellow underbelly have remained unchanged because the hue curve 330 is on a level that produces no change (e.g., applies a gamma value of 1) for the red and yellow hue values. The hue curve is on that level for the red and yellow hue values because the Gaussian bump of hue curve 330 does not reach the red and orange hue values. Furthermore, in the illustrated example, the only change of the hue curve 330 from a flat, centered (e.g., neutral) set of gamma values is the Gaussian bump. After the process 200 applies the modifications to the pixels in the black and white image, the process ends.

Section I describes generating a grayscale image from a color image. Section II describes the process of some embodiments for computing hue values for the color image. Section III describes mechanisms for modifying the shape of the hue curve. Section IV describes several on-screen controls for modifying the grayscale image. Section V describes a software architecture of some embodiments. Section VI describes an image viewing, editing, and organization application of some embodiments. Finally, Section VII describes an electronic system of some embodiments.

### I. RGB to Black and White Conversion

In some embodiments, the color image is converted to an initial black and white (grayscale) image based on accepted grayscale conversion algorithms. In a color image, the qualities (including the color and brightness) of each pixel can be represented as a three dimensional vector (r, g, b). The vector describes the red (r), green (g), and blue (b) components of the pixel color. An image that is stored based on pixels that use an RGB encoding scheme can be referred to as an RGB image. A pixel in an RGB original color image can be converted to a grayscale pixel in a grayscale image by using a function of the r, g, and b components of the pixel to determine a quality of the gray pixel (e.g., the luminance) as shown in equation (1).

luminance=f((r,g,b)) (1)

The function used by some embodiments for determining the luminance of a gray pixel based on the red, blue, and green levels of a color pixel is the dot product of the color vector (r,g,b) and a weighting vector (wᵣ, w_{g}, w_{b}) as shown in equation (2). The weighting vector (wᵣ, w_{g}, w_{b}) is a vector composed of three weighting values, each of which corresponds to one of the colors in the color vector.

luminance=(wᵣ,w₉,w_{b})*(r,g,b)=wᵣr+w_{g}g+w_{b}b (2)

As can be seen in equation (2) there are three color components (r, g, and b) as well as three weighting values, wᵣ, w_{g}, w_{b}. Each weighting value corresponds to one color component. The wᵣ value corresponds to the red (r) component of the pixels. The w_{g} value corresponds to the green (g) component of the pixels and the w_{b} value corresponds to the blue (b) component of the pixels.

Herein, the figures are described using component (r, g, and b) values that vary between 0 and 1. A pixel lacks a particular color component when the corresponding color component's value is 0 for the pixel. A pixel includes a maximum value of a particular color component when the corresponding color component's value is 1 for the pixel. A pixel with a value of (1, 0, 0) is as bright a red as possible. Similarly, a pixel with a value of (0, 1, 0) is as bright a green as possible and a pixel with a value of (0, 0, 1) is as bright a blue as possible. All other colors can be represented as combinations of blue, green and red. For example the brightest white pixel has a value of (1, 1, 1), the brightest yellow pixel has a value of (1, 1, 0), and a black pixel has a value of (0, 0, 0).

One of ordinary skill in the art will understand that although RGB color space is used herein as the color space of the original image, other color spaces of the original image are possible within the scope of the invention. Such other color spaces would have their own weighting values, grayscale conversion formulae, and conversions between the parameterized path color space and the color space of the image.

The described luminance values, herein, vary from 0 (black) to 1 (white). However, one of ordinary skill in the art will understand that the scales used for measuring these quantities are arbitrary and that other scales could be used within the scope of the invention. For example, color components and/or luminance in some embodiments could range from 0 to 255 or between any two values. Similarly, one of ordinary skill in the art will understand that the grayscales of some embodiments may be calculated in luma rather than luminance, and that the image editing applications of some embodiments may calculate how dark pixels are rather than how light they are.

As described herein, individual weighting values (wᵣ, w_{g}, or w_{b}) can be positive or negative. In some embodiments (e.g., embodiments where one or more weighting values are negative), pixels with a calculated luminance less than or equal to zero are converted to black pixels (luminance of 0) in the grayscale image. In some embodiments, when one or more weighting values are positive and the calculated luminance of a pixel is greater than or equal to 1, the pixel is converted to a white pixel (luminance of 1) in the grayscale image. Pixels with a calculated luminance value between 0 and 1 represent gray pixels in the grayscale image. In some embodiments, higher luminance values between the 0 (black) and 1 (white) values represent lighter shades of gray while lower luminance values represent darker shades of gray. In some embodiments, the values of the luminance are not capped. In other embodiments, the values of luminance are not capped while the image is being edited, but are capped when the image is saved in a format with a limited luminance range.

In some embodiments of the image editing applications, the weighting values (wᵣ, w_{g}, and w_{b}) are fixed constants. That is, in such applications the user has no control over the weighting values and can decide only whether to convert a color image to grayscale or not. In other embodiments, the weighting values can be set independently with separate controls for each weighting value. Weighting values are sometimes called “weights”, or “grayscale weighting sets” (or by their component names, red weighting value or red weight, green weighting value or green weight, etc.).

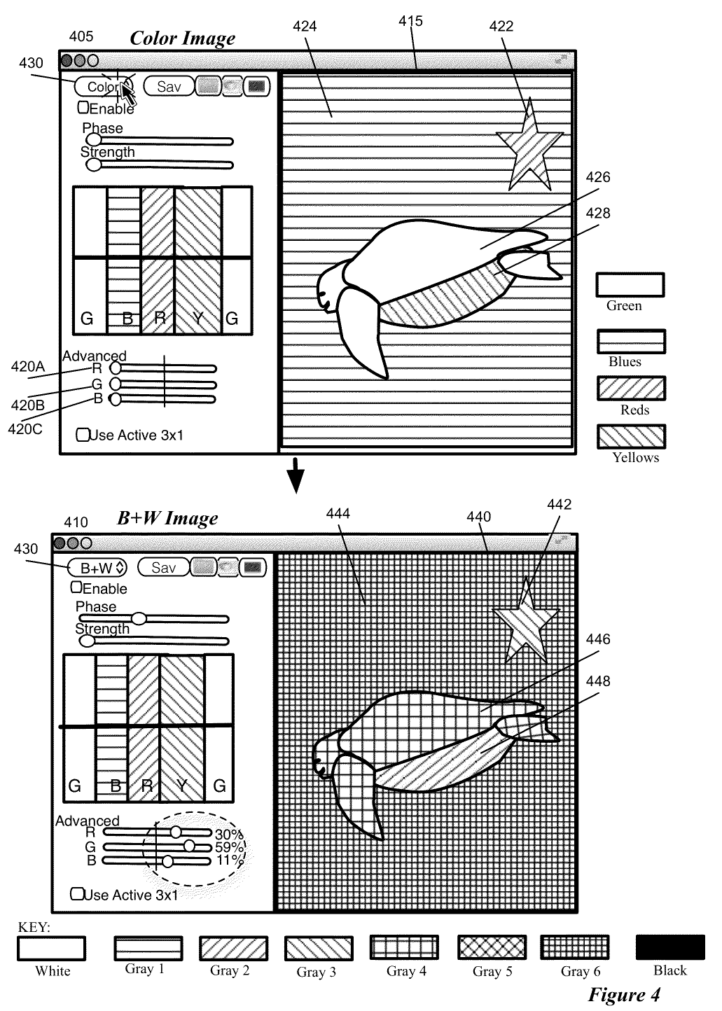

FIG. 4 illustrates two stages 405-410 of the image editing application converting a color image to a grayscale (black and white) image using a three-control, adjustable grayscale converter. The application allows a user to convert a color image to a grayscale image by adjusting the weighting value of each color component independently. Stage 405 of FIG. 4 illustrates application interface 400, grayscale controls 420A-420C, original color image 415. The color image includes a red starfish 422, blue water 424, a green turtle shell 426, and a yellow underbelly of the turtle 428. Stage 405 also illustrates the user selecting the menu option 430 to convert the color image into a black and white image.

In stage 410 the menu 430 now indicates that the color image has been converted to a black and white image. As described above in equation (2), the luminance of a pixel in the grayscale image is determined by computing a weighted sum of the color components of the corresponding color pixel in the original color image. The weights in the weighted sum are set by the RGB controls. In particular, grayscale control 420A controls wᵣ, the weighting of the red component of each color pixel when generating the corresponding grayscale pixel. Grayscale control 420B controls w_{g}, the weighting of the green component of each color pixel when generating the corresponding grayscale pixel. Grayscale control 420C controls w_{b}, the weighting of the blue component of each color pixel when generating the corresponding grayscale pixel.

Grayscale image 440 is a black, white, and gray representation of the original color image 415. Accordingly, the gray water 444 in the grayscale image 440, corresponds to blue water 424 in the color image 415. The gray turtle shell 446 in the grayscale image 440 corresponds to green turtle shell 426 in the color image 415. The gray starfish 442 in grayscale image 440 corresponds to red starfish 422 in the color image. Each of these different areas has a slightly different shade of gray, as determined by the particular RGB to grayscale conversion.

As previously mentioned, each control 420A-420C separately determines how much influence its corresponding color component of the color image 415 will have on the grayscale image 440. In some embodiments of the image editing applications, one or more weighting values can be set to either a positive or a negative value. In such embodiments, when a weight is set to be in a positive range (e.g., 50%), the higher the corresponding component value (r, g, or b) of a pixel is, the more it adds to the luminance of the corresponding grayscale pixel. Conversely, for a component with a weight set to be in a negative range (e.g., −30%), the higher the corresponding component value of a pixel is, the more it subtracts from the luminance of the corresponding grayscale pixel.

In FIG. 4, the weighting values are shown as part of the slider controls and are all positive (i.e., wᵣ=30%, w_{g}=59%, and w_{b}=11%). Accordingly, grayscale pixels corresponding to red pixels, green pixels, and blue pixels will all have luminance above zero (i.e., they will be gray, not black). Therefore all the pixels in areas 442, 444, 446, and 448 of grayscale image 440 (corresponding to areas 422, 424, 426 and 428 of color image 415, respectively) have luminosities above zero.

The three independent slider controls have many settings at which the grayscale image is too bright (i.e., the aggregate weight is too high) and many settings at which the grayscale image is too dim (i.e., the aggregate weight is low or negative). As such, in some embodiments, the image editing application provides an “Active 3×1” option that allows a user to adjust a single slider control in order to determine the weighting factors for the grayscale conversion. Details of the “Active 3×1” tool are described in previously filed U.S. Patent Publication number 2013/0236091 with attorney docket number APLE.P0342, entitled “Method and Interface for Converting Images to Grayscale”. U.S. Patent Publication 2013/0236091, with attorney docket number APLE.P0342, is here incorporated by reference.

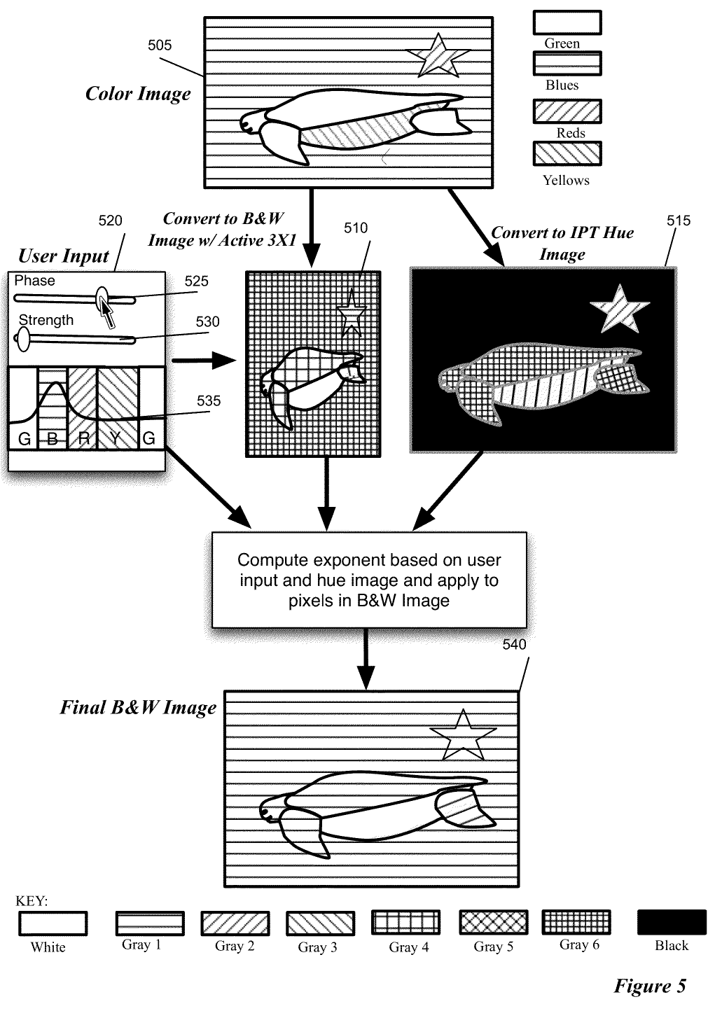

FIG. 5 illustrates a flow diagram similar to the flow diagram of FIG. 3 modified to illustrate the effect of using the “active 3×1” control when converting a color image to a black and white image. In particular, the color image 505 illustrates the image of the turtle in the ocean. In FIG. 3, based on the properties of the color image 305, the image editing application generated the initial black and white image 310 and the hue image 315. The hue image 315 provides a representation of the hue values for each pixel in the color image. In contrast, in FIG. 5, when the image editing application applies the “active 3×1” control, the initial black and white image 510 that is generated is also based on user input received from a phase slider control 525 within the hue control 520. In some embodiments, the phase slider control 525 determines the weighting factors for the R, G, and B values. This is different from FIG. 3 in that the initial black and white image generated in FIG. 3 was generated based on a standard conversion computation. The user would then have to modify the individual R, G, B sliders to set the different weighting factors.

Furthermore, the user may modify the various sliders 525-530 and hue curve 535 within the hue control 520 to further modify the initial black and white image 510 to produce the final black and white image 540. In some embodiments, the image editing application computes a gamma value to be applied to each pixel in the initial black and white image 510 based on the shape of the hue curve 535 and the particular hue value of the pixel. The shape of the hue curve 535 may be modified in some embodiments by using sliders 525-530 or by directly adjusting the hue curve 535.

As illustrated by the final grayscale image 540, the hue curve 535 has effectively lightened the blues and the greens in the image while leaving the remaining hue color values unchanged. As such, the blue water and green turtle shell are now a lighter shade of gray, and the remaining areas of the image are left unchanged. FIG. 5 illustrates that the “active 3×1” control provides the user with the ability to change the weighting values of the color to black and white conversion using only a single slider control rather than the standard 3 R, G, and B sliders. FIG. 6 illustrates the relationship between the single control and the three weighting factors for the grayscale conversion.

In particular, FIG. 6 illustrates moving a single “phase” slider control 645 that automatically changes the color component values for a grayscale conversion of a color image. FIG. 6 illustrates image editing application 600 in four stages 605-620.

Stage 605 of FIG. 6 illustrates the image editing application displaying a color image 630 of the turtle, as indicated by menu item 620. This is the same color image as described above in Stage 105 of FIG. 1. Furthermore, each R, G, and B slider is positioned at a particular weighting value. Stage 605 also illustrates the user selecting menu item 620 in order to convert the color image 630 into a grayscale image. Furthermore, unlike FIG. 4, the user has activated the “Active 3×1” control 625.

Stage 610 illustrates the image editing application has now converted the color image 630 of stage 605 into a grayscale image 640. As such, each color in the original color image 630 is now a different shade of gray within the grayscale image 640. Furthermore, the user is selecting the phase slider 645. When a user adjusts the phase slider 645, the image editing application automatically computes values for each R, G, and B slider. These values are computed based on the single phase slider value that is mapped to different positions along a hue circle (e.g., a parameterized path along the hue color wheel).

Stage 615 illustrates the user has moved the phase slider 645 from the initial midpoint position to the left. As such, the image editing application has automatically changed the R, G, and B sliders to various new positions based on the adjusted phase value. Stage 620 illustrates the user has moved the phase slider 645 to the right. Accordingly, the image editing application has automatically modified the R, G, and B sliders based on the new position of the phase slider 645. In particular, the image editing application has decreased the R value from stage 615 and increased the B and G slider values. As such, the pixels corresponding to the blue and green pixels in the color image have been lightened from stage 615 and the yellow and red pixels have been darkened for the increased weight.

Regardless of the conversion mechanism for generating the initial grayscale image from the color image, the image editing application computes hue values for each pixel in the color image based on the R, G,B values in the color image. The image editing application then uses these computed hue values in order to perform the hue based enhancements on the grayscale image. Section II below describes the process of some embodiments for computing hue values for a color image.

### II. RGB to Hue Computation

In addition to generating an initial black and white image from the color image, the image editing application generates a hue mapping of the color image that provides hue values for each pixel in the image based on the (RGB) color values of the pixel. The hue value of a particular pixel and the corresponding hue curve then determine the amount of modification (i.e., gamma adjustment) that gets applied to the pixel in the black and white image to produce the enhanced black and white image. FIG. 7 illustrates a process 700 for computing hue values for pixels in the grayscale image based on the color values of the pixels in the color image. The process 700 initially receives (at 705) a color image that contains numerous pixels, each pixel having a corresponding (r,g,b) color value. The process then converts (at 710) the RGB values into a standard CIE XYZ color space. In order to convert to the CIE XYZ space, the process applies a standard conversion matrix to each (r,g,b) value according to equation (4) below:

$$[ \begin{matrix}X \\ Y \\ Z\end{matrix} ] = [ \begin{matrix}0.4124564 & 0.3575761 & 0.1804375 \\ 0.2126729 & 0.7151522 & 0.0721750 \\ 0.0193339 & 0.11991920 & 0.9503041\end{matrix} ] \cdot [ \begin{matrix}R \\ G \\ B\end{matrix} ] \qquad ( 4 )$$

In particular, equation (4) above computes the matrix multiplication of the RGB values of a pixel with the standard conversion factors to obtain the XYZ values for the pixel. The process 700 then converts (at 715) the (X,Y,Z) into LMS cone responses by applying a second matrix multiplication using a second conversion matrix, as illustrated according to equation (5) below:

$$[ \begin{matrix}L \\ M \\ S\end{matrix} ] = [ \begin{matrix}0.4002 & 0.7075 & - 0.807 \\ - 0.2280 & 1.1500 & 0.0612 \\ 0.0 & 0.0 & 0.9184\end{matrix} ] \cdot [ \begin{matrix}X \\ Y \\ Z\end{matrix} ] \qquad ( 5 )$$

The process 700 then non-linearly compresses (at 720) the (L,M,S) according to equation (6) below:

$$\begin{matrix}{L}^{′} = \{ \begin{matrix}{L}^{0.43} ; & L \geq 0 \\ - {\vert L \vert}^{0.43} ; & L \leq 0\end{matrix} \} & ( 6 ) \\ {M}^{′} = \{ \begin{matrix}{M}^{0.43} ; & M \geq 0 \\ - {\vert M \vert}^{0.43} ; & M \leq 0\end{matrix} \} & ( 6 ) \\ {S}^{′} = \{ \begin{matrix}{S}^{0.43} ; & S \geq 0 \\ - {\vert S \vert}^{0.43} ; & S \leq 0\end{matrix} \} & ( 6 )\end{matrix}$$

The process 700 then converts (at 725) the (L′, M′, S′) into the IPT color space by applying a third conversion matrix, illustrated according to equation (7) below:

$$[ \begin{matrix}I \\ P \\ T\end{matrix} ] = [ \begin{matrix}0.4000 & 0.4000 & 0.2000 \\ 4.4550 & - 4.8510 & 0.3960 \\ 0.8056 & 0.3572 & - 1.1628\end{matrix} ] \cdot [ \begin{matrix}{L}^{′} \\ {M}^{′} \\ {S}^{′}\end{matrix} ] \qquad ( 7 )$$

The process 700 then computes (at 730) a hue value for each pixel at location (x,y) based on equation (8) below:

hue(x,y)=arctan 2(T,P) (8)

In equation (8) above, the arctan2 function computes the hue angle (in radians or degrees) for a particular pixel at location (x,y). As such, each pixel in the image is mapped to a corresponding hue value (or angle) within the range of hue color values. The process 700 then ends.

After the application determines hue values for each pixel in the image, the user may now command the application to apply hue based enhancements to the grayscale image in order to generate the enhanced grayscale image. Different hue based enhancements are applied to different grayscale pixels based on the computed hue values of the pixels. In some embodiments, the image editing application provides various different controls, including a hue control tool, that the user may use to modify the grayscale image.

### III. Modifying Hue Curve

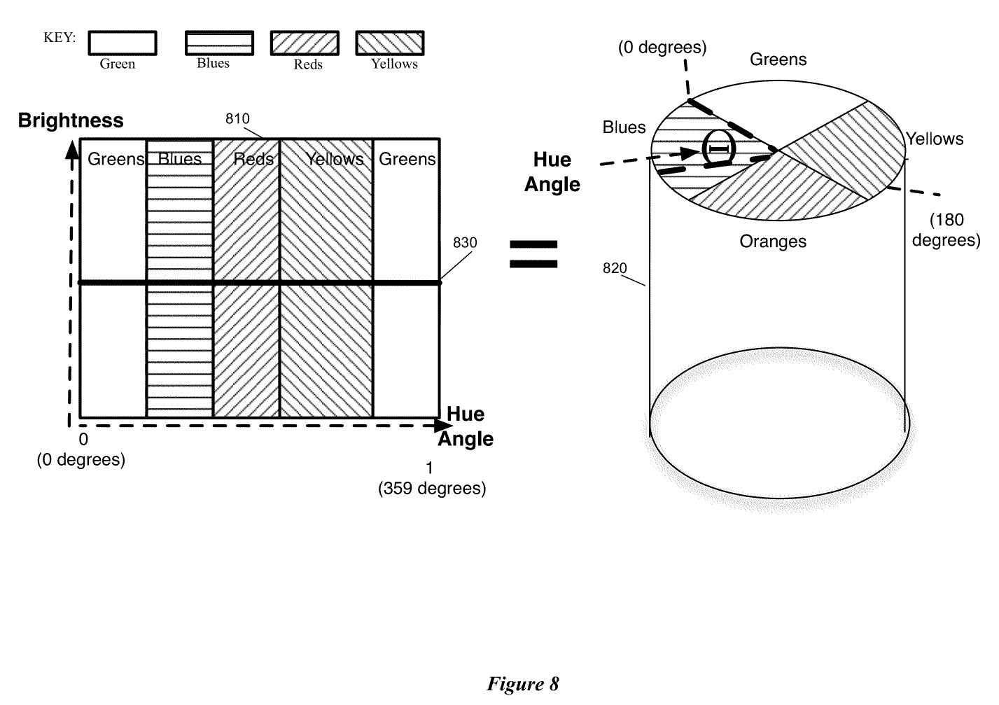

FIG. 8 illustrates a hue control 810 that is displayed in the user interface of some embodiments of the image editing application. The hue control 810 includes a hue curve 830 (illustrated as a flat line in this example), the shape of which determines the gamma values to apply to the grayscale pixels. Regardless of whether the hue control 810 is displayed within the user interface of the image editing application, the application may still compute as a background process values based on the shape of such a curve 830.

FIG. 8 also illustrates the relationship between the hue control 810 and the standard hue color cylinder 820. Hue control 810 illustrates the range of hue color values along the x-axis, ranging from shades of greens to blues to reds to yellows and back to greens. For simplicity purposes, the hue control 810 illustrates the changing shades of colors as discrete uniform rectangular areas within the range. However, the hue values, corresponding to different colors are constantly changing along the x-axis, similar to the colors around the hue color wheel. As indicated, these color values correspond to hue values (or angles) of 0 degrees to 360 degrees or values of [0-1] depending on the particular range of values used to define the hues.

The hue control 810 is related to the hue color cylinder 820. In particular, values along the x-axis of the hue control 810 map to values around the circumference of the hue cylinder 820. In particular, the colors along the outer perimeter of the cylinder 820 represent the standard circular hue color wheel with colors along the wheel ranging from green (0 degrees) to blue to orange (180 degrees) to yellow and back to green (359 degrees). Each particular position (or angle), illustrated as “theta” in the cylinder 820 corresponds to a different hue color value within the range of hue colors. Furthermore, because a hue value along the x-axis determines an angle along the hue color circle 820, a value of, for example 361 degrees on the x-axis is equal to a value of 1 degree on the hue color circle 820. However, in some embodiments, the x-axis of the hue control only provides hue range values for one complete cycle around the perimeter of the hue color cylinder, and thus the leftmost point on the hue curve along the x-axis within the hue control corresponds to an angle of 0 degrees and the rightmost point along the hue curve corresponds to an angle of 359 degrees. As such, when a user adjusts the hue curve at positions near the endpoints of the hue range, the image editing application may also adjust, depending on the particular computations, the hue curve at the opposite end of the hue range due to the circular nature of the color wheel. Thus, when a user creates a Gaussian bump at, for example 359 degrees, the values of the hue curve at 0 degrees (and near 0 degrees) will be modified depending on the particular values that are computed for the hue curve computations.

Furthermore, the y-axis of the hue control 810 determines the gamma value to apply to a particular pixel. The gamma value determines how light or dark a shading of a gray pixel is. The hue curve 830 specifies gamma values for each different hue value in the range of hue values. As the gamma value for a particular hue approaches the top of the hue control 810 the shade of gray of a particular pixel of that hue will be lightened. In contrast, as the gamma value for a particular hue approaches the bottom of the hue control 810 the shade of gray of a particular pixel of that hue will be darkened. A gamma value along the middle curve 830 leaves the pixel unchanged.

In some embodiments, the hue curve 830 across the x-axis is initialized as a straight line along a midpoint at which values above the line will lighten the shade of gray of pixels and values below the line will darken the shade of gray of pixels. The shape of the hue curve 830 within the hue control 810 determines exactly which grayscale pixels in the initial black and white image should be lightened, which pixels should be darkened, and which pixels should remain unchanged. The user may utilize a variety of mechanisms in order to specify these enhancements, including directly manipulating the shape of the hue curve 830 within the hue control 810, manipulating various adjustable sliders, and manipulating various other on-screen controls.

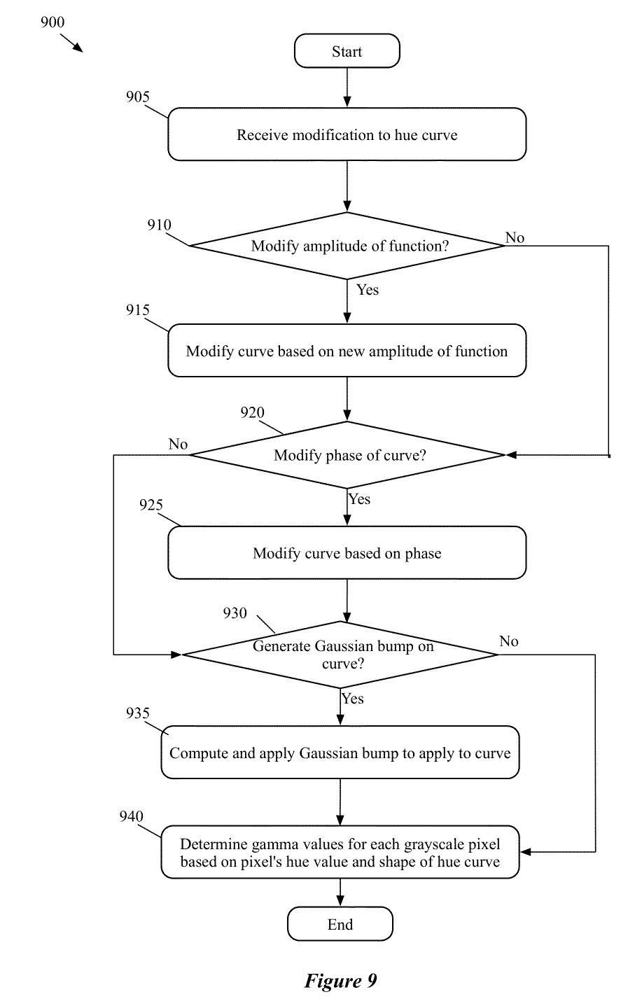

FIG. 9 illustrates a process 900 for determining the shape of the hue curve and computing the gamma value to apply to a particular pixel. The particular order in which the steps are executed represents one possible embodiment. Other embodiments may execute these steps simultaneously or in a different order than those illustrated in the figure.

The process 900 initially receives (at 905) a modification to the shape of the hue curve. The modification can be received through several mechanisms. For example, the user may modify the height of the hue curve at a given point by using any one of 1) a slider control, 2) directly dragging the curve to increase or decrease the height of the curve at and around the point that is dragged, or 3) applying on-screen controls (e.g., a touching gesture or a select and drag) directly on certain pixels of the image which modifies the shape of the hue curve. Based on the particular user input, the process 900 determines (at 910) whether the user input is directed towards modifying the amplitude of a function (e.g., a sine function) imposed on the hue curve. If the user input modifies the amplitude of the function, the process computes (at 915) various values that determine the shape of the curve across the range of hue color values based on the new amplitude.

FIG. 10 illustrates three stages 1005-1015 of a user modifying the amplitude (or strength) of a function imposed on the hue curve using an adjustable slider tool. In this particular example, the function is a sine wave, although other types of functions are used in some embodiments. As illustrated in stage 1005, the image editing application includes an image display area 1020, the hue control 1025, the hue curve 1030, phase slider 1035, and strength (“str”) slider 1040. The image display area 1020 is currently displaying the image of the swimming turtle in black and white (grayscale), as indicated by the menu item 1045. As such, the colors of the image have all been converted to different shades of gray. In particular, the blue water 1050 is displayed as the darkest shade of gray (at gray 5), the green shell 1055 is the next darkest shade of gray (at gray 4), the yellow underbelly 1060 (gray 2) and the red starfish 1065 (gray 3) are both a lighter shade of gray. In stage 1005, the strength slider 1040 is at a position that corresponds to 0 strength. Additionally, no Gaussian bumps have been added to the hue curve 1030. Therefore, the hue curve 1030 is flat. In particular, in order to determine the shape of the hue curve (i.e., the shape of the sine wave), the image editing application applies the following equation (9):

γ=str*sin(hueθ+phase) (9)

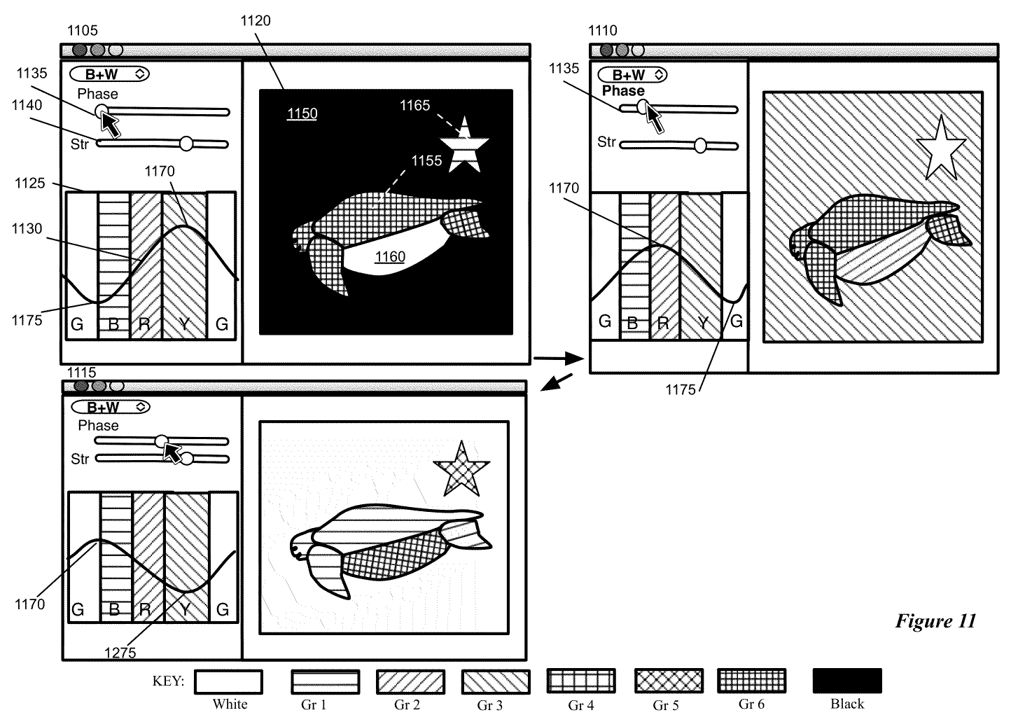

In equation (9), the gamma (“γ”) for each hue value in the range of hue values is computed based on the strength (str) received from either the slider control (or other user input) multiplied by the sine of the particular hue value (taking into account any phase adjustments that may be applied, as described in FIG. 11, below). A standard property of the sine wave is that it provides values that range from [−1 to 1], as illustrated by graph 1080, and thus the hue curve 1030 fluctuates from negative (str) to positive (str), as illustrated by the graph of the sine wave 1080. In some embodiments, the strength is set to a fixed value. In some embodiments, the gamma (“γ”) value is renormalized before it is applied to the grayscale (e.g., luminance) pixel values. For example, in some embodiments, the gamma values are renormalized from a −1 to 1 range into a 0 to 2 range. In particular, a gamma value of 0 as computed by equation (9) is renormalized to a gamma value of 1 before it is applied to the grayscale pixel values. After renormalizing the gamma values from a −1 to 1 range into a 0 to 2 range, in some embodiments, equation (12) described below is used to compute the actual gamma exponent values (based on the 0-2 range) before they are applied to the pixel values using equation (13) also described below.

In stage 1005, because the slider is at zero strength, the hue curve 1030 is completely flat (multiplying the sine by a strength value of 0 results in a hue curve value of 0, corresponding to a gamma of 1 and an unchanging grayscale value). Thus there is no change to the initial black and white image of the turtle 1020 that was generated for the color image. In stage 1005, the user is selecting the strength slider 1040 in order to adjust the strength value.

In stage 1010, the user has selected and dragged the slider 1040 to a new position that is slightly less than half strength. As such, the shape of the hue curve 1030 is now in the form of a sine wave with a strength value that produces a peak 1070 and a trough 1075 with a particular amplitude at certain locations along the hue range. In particular, the peak 1070 of the hue curve 1030 spans primarily across the oranges and reds of the hue color range while the trough 1075 spans across the greens and blues of the hue color range. As such, the image of the swimming turtle 1020 has been modified. In particular, the shades of gray in the grayscale image corresponding to the blues and greens in the original color image have been darkened while the shades of gray corresponding to the reds, oranges, and yellows have been lightened. As illustrated, the blue ocean water 1050 is now at gray 6 (from 5) and green turtle shell 1055 is now at gray 5 (from 4), which are darker shades of gray than in stage 1005. Likewise, the yellow underbelly 1060 is now at gray 1 and the red starfish 1065 is at gray 2, which are both lighter shades of gray compared to stage 1005.

In stage 1010, the application computed some lightening gamma values for the reds, oranges, and blue hue values, and some darkening gamma values for the blues and greens (based on the value of the strength multiplied by the sine of the particular hue value). After computing the gamma values based on equation (9) above, the values are normalized and converted to a particular range of values prior to being applied to the grayscale pixel values. This series of computations is discussed below with respect to the final step (at 935) of the process 900.

Stage 1015 of FIG. 10 illustrates that the strength slider 1040 has increased even more from stage 1010, producing a sine wave with an increased amplitude. In particular, the strength slider is almost at a maximum strength value. Therefore, the height of the peak 1070 of the hue curve is at a higher point than in stage 1010 and likewise the trough 1075 is at a lower point, thus providing a greater contrast than in stage 1010. In particular, the peak 1070 of the hue curve 1030 is significantly lightening the reds/oranges/yellows while the trough 1075 is significantly darkening the blues and greens. As such, the image of the swimming turtle 1015 now displays the blue ocean water 1050 as almost black and the green shell 1055 as a very dark gray (at gray 6). In contrast, the yellow underbelly 1060 (white) and the red starfish 1065 (gray 1) are at very light grays or almost white. Thus by adjusting the strength slider 1040, the user has been able to lighten certain grayscale pixels in the image and darken other grayscale pixels using the original hue color values of the pixels within the original color image.

FIG. 10 illustrates one mechanism for adjusting the hue curve using a strength slider control. In some embodiments, the application provides other controls and mechanisms for adjusting the curve, including direct manipulation of the curve, on-screen (or on image) controls, and various other mechanisms. Referring back to FIG. 9, after determining whether or not to modify the amplitude of the hue curve, the process 900 then determines (at 920) whether or not to modify a phase of the function imposed on the hue curve. In some embodiments, the phase of the function determines the particular position of the function on the hue curve across the hue color spectrum according to equation (9) described above.

FIG. 11 illustrates three stages 1105-1115 of a slider control for modifying the phase of the function on the hue curve. Stage 1105 illustrates the image editing application displaying the image of the swimming turtle in the image display area 1120. In stage 1105, the phase slider 1135 is positioned at the beginning of the slider. The hue curve 1130 is displayed within the hue control 1125 with a particular shape, as determined by both the position of the strength slider 1140 and phase slider 1135. In particular, the peak 1170 of the sine function on the hue curve 1130 is positioned primarily over the reds/oranges/yellows hue values while the trough 1175 is positioned primarily over the greens/blues hue values. As such, the image displays the blue water 1150 as an almost black (or very dark shade of gray), and the green shell 1155 as a very dark gray (at gray 6). Likewise the yellow underbelly 1160 (at white) and red starfish 1165 (at gray 1) are displayed as very light shades of gray. Stage 1105 also illustrates the user is selecting the phase slider 1135 in order to modify the phase of the sine function on hue curve 1130.

Stage 1110 illustrates that the user has moved the phase slider 1135 to a new position along its range. By adjusting the phase slider 1135, the hue curve 1130 has moved across the range of hue color values such that the peak 1170 and trough 1175 are positioned at a new position along the range of hue color values. In particular, the peak 1170 of the hue curve 1130 has advanced such that it is now positioned over the blues (and purple/red) hue values while the trough 1175 is over the yellows and the greens hue values. As such, the blue water 1150 is now a much lighter shade of gray (at gray 3) than in stage 1105. Likewise, the yellow underbelly 1160 (at gray 2) has experienced a darkening of its shade of gray from stage 1105, since the trough 1175 of the hue curve 1130 is now positioned over the yellows. The green shell 1155 (at gray 6) and red starfish 1165 (at white from gray 1) experienced lesser changes in their shades of gray based on this particular shape of the hue curve 1130 along these particular hue values as compared to stage 1105.

In stage 1115, the user has moved the phase slider 1135 to another different position that is almost at the midpoint of the slider (e.g., corresponding to a phase change of 180 degrees). Thus, the hue curve 1130 is almost at a complete opposite shape than in stage 1105. As such, the peak 1170 of the hue curve 1130 lies primarily over the greens and the blues while the trough 1175 of the hue curve 1130 lies primarily over the yellows/oranges/reds. As such, the blue water 1150 (at white) and green shell 1155 (at gray 1) are now a very light shade of gray as compared to stage 1105. Likewise, the yellow underbelly 1160 (at gray 6) and the red starfish 1165 (at gray 5) are a very dark shade of gray as compared to stage 1105. By adjusting the phase slider, the user is able to traverse the hue curve (i.e., sine wave) across the hue color range.

Referring back to FIG. 9, after the process 900 determines (at 920) whether or not to modify the phase of the function imposed on the hue curve, the process determines (at 930) whether to apply Gaussian bumps (i.e., Gaussian distribution) to the hue curve. In some embodiments, when a user modifies a particular area of the grayscale image, the image editing application modifies the shape of the hue curve by computing and applying Gaussian bumps to the curve. The image editing application computes the Gaussian bumps according to the following equation (10):

$$g = str * {e}^{- \frac{{( hue - pick )}^{2}}{{w}^{2}}} \qquad ( 10 )$$

In equation (10) above, g is the amount of the Gaussian bump that is to added to the hue curve at a particular hue value hue. Str is a user input amount regarding how small or large to make the Gaussian bump. The str value may be determined based on how far a user drags a point along the hue curve in a particular direction, or how much of an on-screen touch input is received by the image editing application. Hue is the particular hue value within the range of hue values and pick is the hue value of the pixel that the user selected to receive the Gaussian bump. W is a constant that is selected that determines the width of the Gaussian bump, in particular, the range of hue values that will be affected by the Gaussian distribution. In some embodiments, the width is set to a default constant width of 0.075 in hue angle [0-1], or 27 degrees in hue angle [0-360] degrees. In some embodiments, the width (w) may be adjustable based on user input.

After computing the Gaussian bump (g) in equation (10) above, these bumps are then added back to the original hue curve (e.g., as determined by equation (9)) according to equation (11):

γ=(initial hue curve)+g (11)

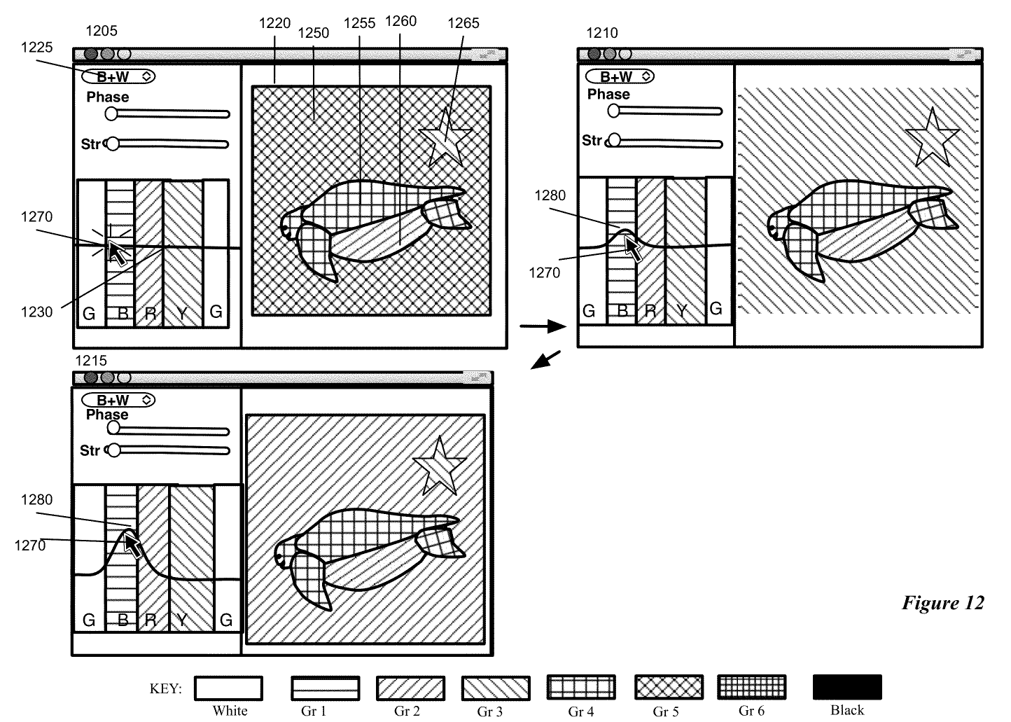

FIG. 12 illustrates in three stages 1205-1215 a user adding a Gaussian bump to the hue curve. In this particular example, the user is directly modifying the hue curve (i.e., by selecting and dragging the hue curve) to add the Gaussian bump. In some embodiments, the image editing application applies a Gaussian bump to the hue curve when a user provides other types of input, including through various on-screen controls, or by adjusting different sliders.

Stage 1205 illustrates the image editing application displaying an image of a swimming turtle in the image display area 1220. As indicated by menu item 1225, the image is a black and white (grayscale) image. The image includes various different shades of gray, including the darkest gray used for the blue water 1250 (gray 5), the next darkest gray used for the green shell 1255 (gray 4), and lighter shades of gray used for the yellow underbelly 1260 (gray 2) and red starfish 1265 (gray 3). The shape of the hue curve 1230 within the hue control is currently flat, indicating that the image has not been modified beyond the initial standard conversion from the color image to the grayscale image. Furthermore, the user is selecting, with a cursor control 1270, a position along the hue curve 1230 that is located within the blue range of hue color values.

Stage 1210 illustrates that the user has selected and is dragging the hue curve 1230 upwards, thereby creating a Gaussian bump along the hue curve 1230. The width of the Gaussian bump is primarily distributed across the green and blue hue values. The particular shape of the bump was determined based on equation (10), above. As such, the image of the swimming turtle now displays the blue water 1250 (at gray 3 from 5) as a lighter shade of gray than in stage 1205. The remaining areas of the image (e.g., the green shell 1265, yellow underbelly 1260, and red starfish 1265) have been left largely unchanged and have the same gray values since the Gaussian bump did not affect the hue values outside of the range of the Gaussian bump. Although not illustrated in this stage, if a user modifies a portion of the hue curve 1230 that is near either the left or right endpoint of the hue range, the image editing application will also modify the portion of the hue curve on the opposite end of the hue range, depending on the particular values that are computed for the Gaussian bump. This is due to the fact that the hue control along the x-axis specifies values that map to the circular hue color cylinder, and thus are continuously revolving around the circle. For example, the rightmost point of the hue curve 1230 may correspond to a hue angle of 359 degrees (in [0-360 degree range], and thus the next subsequent hue angle (i.e., 360 degrees) would be 0 degrees, which is at the leftmost point of the hue curve.

Stage 1215 illustrates that the user has dragged the particular point on the hue curve further than in stage 1210. Thus the peak of the Gaussian bump 1280 has increased from stage 1210. In particular, the extent to which the user drags a particular point along the curve determines the str value that is used in equation (10). In some embodiments, the str value can range from [−1 to 1] based on whether the user drags the hue curve upwards or downwards. Other embodiments may use a different range of strength values.

As illustrated in Stage 1215, the image now displays the blue water 1250 (at gray 2 from 3) at an even lighter shade of gray than both stages 1205 and 1210. Since the Gaussian bump is positioned primarily over the blue hue values, only pixels in the grayscale image that have a hue value within this particular range are affected by the addition of the Gaussian bump 1270 to the hue curve 1230. Although not illustrated in the figures, the user may add multiple Gaussian bumps at different points along the hue curve. The strength of each Gaussian bump may be different based on the particular amount of user input received by the image editing application. Furthermore, in some embodiments, the user may adjust both the strength and the width of a Gaussian bump using a variety of input mechanisms, including modifying control points placed along the hue curve, slider controls, and on-screen controls.

Referring back to process 900 in FIG. 9, after the process computes and applies (at 935) the Gaussian bump to the hue curve, the process (at 940) determines gamma values for each grayscale pixel based on the pixel's hue value and the shape of the hue curve. As described above, in some embodiments, the various gamma (“γ”) values are all renormalized into a [0-2] range, with a value of 1 representing no change. Then, the exponent gamma values that are to be applied to each grayscale pixel value are computed based on the following equation (12).

$$γ = if \{ \begin{matrix}γ \leq 1 , & 3 - 2 γ \\ else , & 1 - .55 ( γ - 1 )\end{matrix} \qquad ( 12 )$$

After the exponent γ is computed for a grayscale pixel, the process computes the final grayscale pixel value based on the following equation (13):

pixel=pixel^{γ} (13)

For example, in some embodiments, a gamma value of 0 as computed by equation (9) for a [−1 to 1] range, described above, is renormalized to a value of 1 in a [0 to 2] range. In order to renormalize from [−1 to 1] to [0 to 2], the process may, for example, add 1 to each computed gamma value in equations (9), (10), (11). After renormalizing into the [0 to 2] range, the process then computes the actual exponent value for the gamma value according to equation (12) before it is applied to a grayscale pixel value using equation (13). For a gamma value of 1, the exponent gamma value (γ) is computed, using equation (12) as 1. Thus the pixel value remains the same based on equation (13).

Each grayscale pixel is modified based on its computed gamma value in order to produce the enhanced grayscale image. After the process 900 applies these gamma values to the pixels, the process ends.

FIGS. 10-12 illustrate different mechanisms for adjusting the shape of the hue curve along the hue color spectrum, including the use of various sliders (e.g., phase and strength) to adjust a function (e.g., a sine function) imposed on the hue curve and direct manipulation of the curve using Gaussian bumps. In some embodiments, the image editing application provides on-screen controls for enhancing a grayscale image.

### IV. On Screen Controls

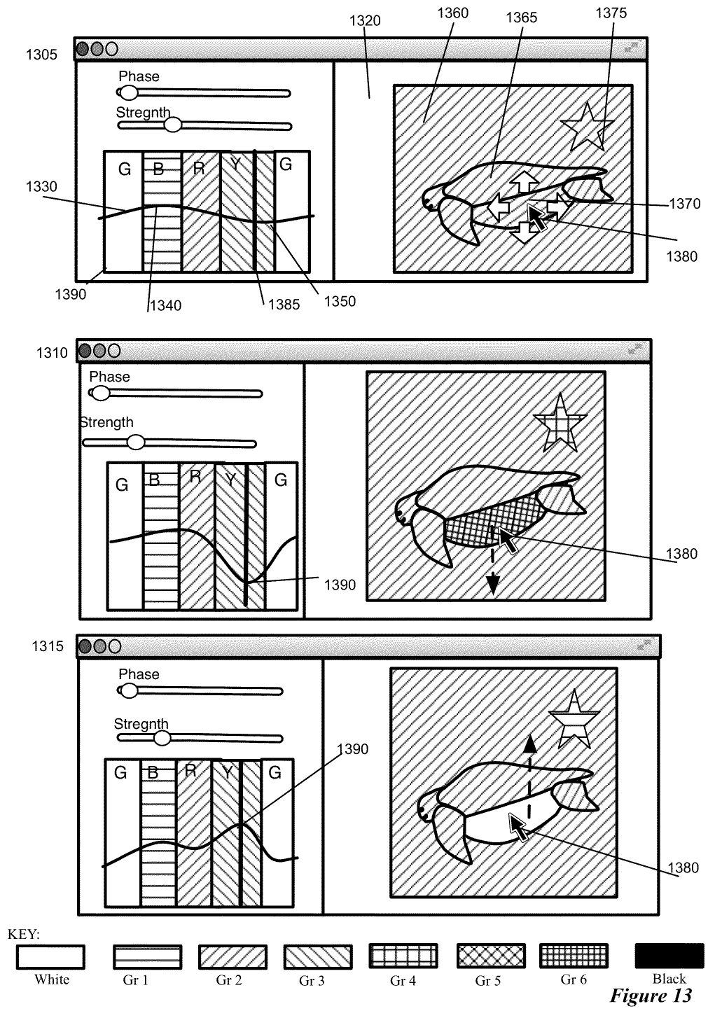

FIG. 13 illustrates three stages 1305-1315 the image editing application modifying a grayscale image through on-screen input. Stage 1305 illustrates the image editing application displaying in the image display area 1320 an image of a swimming turtle. The image is being viewed as a grayscale image, with different shades of gray used for different areas of the image. The hue curve 1330 is in the shape of a sine wave (with a minimal amount of amplitude) with a peak 1340 positioned primarily over the blues/green hue values and the trough 1350 positioned over the yellow/orange/red hue values. In this particular example, for purposes of simplicity, the image of the turtle displays the blue water 1360, the yellow underbelly 1370, the green shell 1365 and red starfish 1375 at the same shade of gray (gray level 2).

Stage 1305 also illustrates the user selecting, with a cursor control 1380, a particular pixel that is located within the yellow underbelly 1370 of the turtle. Since the user has selected this particular area of the grayscale image, the image editing application also provides an indicator bar 1385 within the hue control 1390 that provides an indication of the selected pixel's hue value within the hue color spectrum. The indicator bar 1385 indicates that the hue value is somewhere within the yellow hue values of the hue color range (as the underbelly 1370 of the turtle within the original color image was yellow). After selecting the particular area of the image with the cursor control 1380, the image editing application displays four arrows that indicate different directions that the user may move or drag the cursor 1380 to apply a different effect to the image.

Stage 1310 illustrates that the user is selecting and dragging the cursor control 1380 downwards on the image while selecting the underbelly 1370 in the image. This has the effect of darkening all of the pixels in the image that have the same (or similar) hue values within the image. As illustrated, the hue curve 1330 has applied a (downward) Gaussian bump 1390 that spans primarily over the yellow/orange/red hue values. The particular nature of the Gaussian bump 1390 was computed based on equations (10) and (11) described above. As such, pixels within the grayscale image that have hue values within the yellow/red/orange hue values have experienced a darkening effect, while the pixels with hue values outside of the width of the Gaussian bump have been left largely unaffected. The image now displays the yellow underbelly 1370 (now at gray 6) and red starfish 1375 (now at gray 4) with a darker shade of gray than in stage 1305. Likewise, the blue water 1360 and green shell 1365 appear with the same (or very similar) gray shade as in stage 1305.

Stage 1315 illustrates the effect of dragging the cursor control upwards. In particular, in stage 1315 the user has selected the underbelly 1370 with the cursor control 1380 and dragged the cursor in an upwards direction. Selecting a particular area (or pixel) and dragging upwards has the effect of lightening the particular shade of gray of the pixel and all other pixels with the same (or similar) hue values, as determined by the particular nature of the Gaussian bump across the hue color spectrum. As illustrated, the hue curve 1330 has been modified to add a Gaussian bump 1390 that is directed upwards on the curve. The Gaussian bump spans primarily across the red/yellow hue values of the hue color spectrum. Thus pixels in the grayscale image with hue values within this range experience different amounts of lightening, depending on the pixel's hue value in relation to the hue curve. As illustrated, since the Gaussian bump 1390 spans primarily over the yellow/red hue values, the yellow underbelly 1360 (now at white) and red starfish 1375 (now at gray 1) have both experienced a lightening of their shades of gray from stages 1305 and 1310. The user may select on any particular area (or pixel) within the image and drag up or down to either lighten or darken all pixels in the image with similar hue values (as determined by the particular Gaussian bump applied to the curve). In some embodiments, when a user selects a particular area and drags upwards or downwards, the image editing application modifies the strength value (e.g., the amplitude) of the particular hue curve rather than modifying the curve to add Gaussian bumps. In these embodiments, modifying a particular pixel will also change the shape of the hue curve by increasing or decreasing the amplitude of the sine wave across all pixels in the hue color spectrum.

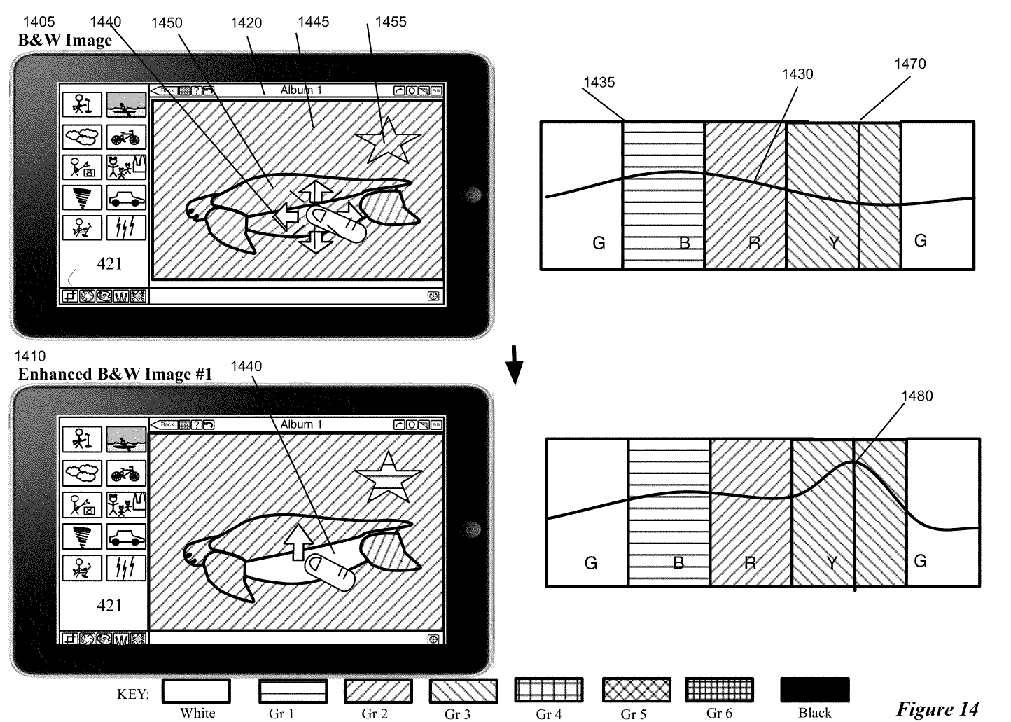

FIG. 13 illustrates modifying a grayscale image using a cursor control directly over the image. In some embodiments, the image editing application executes on a mobile device or other device that is capable of receiving touch and gestural input. FIG. 14 illustrates an example of modifying a grayscale image through touch input on a mobile device. FIG. 14 illustrates two stages 1405-1410 of the image editing application receiving a user's touch input to modify the grayscale image. As illustrated in stage 1405, the image editing application is executing on a mobile device of the user. The mobile device may include a tablet device such as iPad® sold by Apple, Inc. or a smartphone such as iPhone® sold by Apple Inc.

In some embodiments, the user interface of the image editing application does not display the hue control and hue curve within the display area. However, the manner in which the grayscale image is modified is still determined based on the shape of the hue curve across the hue color spectrum, as computed in a background process. Accordingly, in the illustrated embodiment, a hue curve 1430 and a hue control 1435 are shown for conceptual clarity, rather than as an illustration of what the user of the mobile device of this embodiment would see. Stages 1405 and 1410 both illustrate the underlying hue curve 1430 that corresponds to each particular stage, even though the user may not necessarily be able to see the hue curve 1430.

Stage 1405 illustrates the image editing application executing on a mobile device. The image editing application is displaying the image of the swimming turtle within the image display area 1420. Furthermore, the user is directly touching an area of the image on the yellow underbelly 1440 of the turtle. For reasons of clarity, in the figure, the hue control 1435 (not displayed on the user device) provides an indicator 1470 that corresponds to the particular hue value for the pixels/area that the user is touching within the image display area 1420. In particular, the shade of the gray pixels of the turtle's underbelly 1440 correspond to pixels that have hue values within the yellow portion of the hue color spectrum.

Stage 1405 illustrates that upon touching the image display area 1420, the image editing application presents four arrows (up, down, left, and right) in order to provide an indication to the user that they may swipe or apply other types of gestural input (e.g., drag, move etc.) their finger in the different directions in order to apply different effects to the image.

Stage 1410 illustrates the user dragging their finger upwards after touching the underbelly 1440 of the turtle. Dragging in an upwards direction causes the image editing application to lighten the shade of gray of those pixels with the same or similar hue values as the pixels that the user is touching within the image. Since the user is touching the grayscale pixels that were originally yellow within the color image, the image editing application has lightened the shade of gray of these pixels as compared to stage 1405. Thus the underbelly 1440 is now almost white and the red starfish is at gray 1 since the shape of the hue curve 1430 has changed such that a Gaussian bump with a peak 1480 spanning the yellow/red hue values has been added to the hue curve 1430. The remaining portions of the image have retained essentially the same gray shading values since the Gaussian bump largely affects only pixels within a certain hue range within the bump 1480.

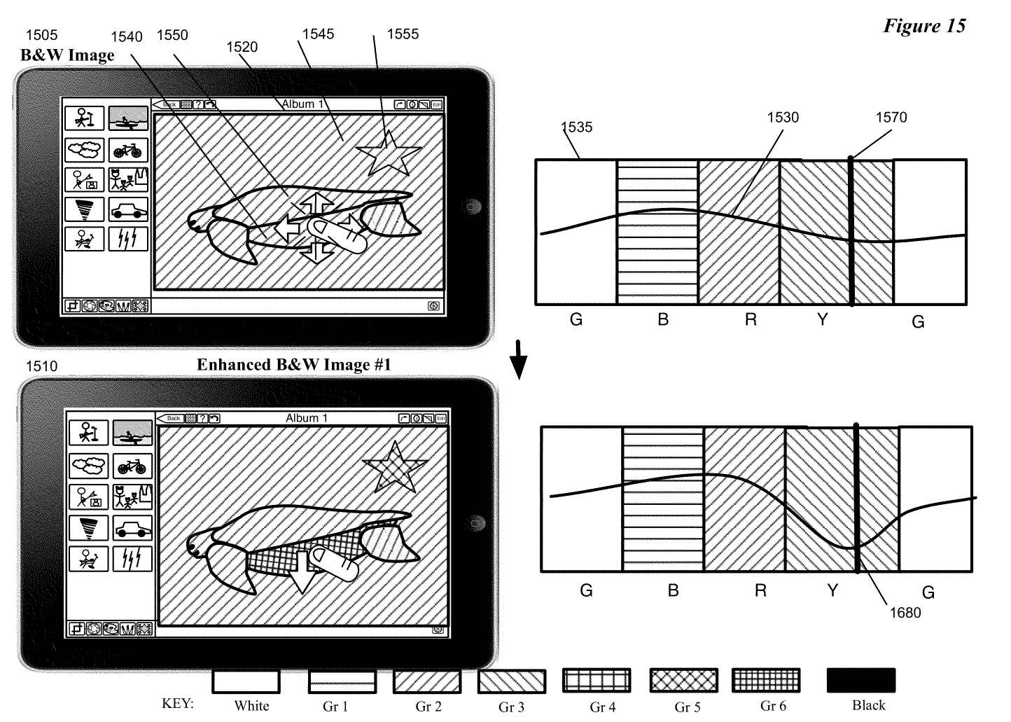

Similarly to FIG. 14, FIG. 15 illustrates the effect of a user touching and dragging downwards on the image display area in order to darken the particular shade of gray of certain areas of the image. Similarly to stage 1405 of FIG. 14, stage 1505 of FIG. 15 illustrates the user touching the underbelly 1540 of turtle and being presented with four arrows indicative of different directions that the user may move their finger to apply different effects to the image. As illustrated, the shape of the hue curve 1530 is the same as in stage 1405 of FIG. 14, and appears as a sin wave with a minimal amplitude.

Stage 1505 illustrates the user has dragged their finger downwards after touching the area (pixels) within the underbelly 1540 of the turtle. These grayscale pixels correspond the yellow pixels in the color image and thus their hue values lie within the yellow portion of the hue color spectrum, as indicated by the indicator line 1570 within the hue control 1535. In some embodiments, the hue control 1535 and the indicator line 1570 are not visible to the user. When the image editing application receives a downward dragging over a particular area of the image, the application darkens those pixels in the image with hue values within a particular range of the selected pixels hue values. These affected pixels lie within the Gaussian bump 1580 that is applied to the hue curve 1530 based on the direction and extent of the users touch and drag gesture. As illustrated, the hue curve 1530 for stage 1510 illustrates that the hue bump 1580 (directed downwards) has darkened the red/orange/yellow hue values within the hue color spectrum. As such, the yellow underbelly 1540 (at gray 6) and red starfish 1555 (at gray 5) have experienced a darkening of their particular shades of gray from stage 1505. The extent to which different pixels are darkened depends on the particular shape of the hue curve. Thus pixels that are near the ends of the Gaussian bump do not experience the same level of modification as those pixels with hue values at or near the peak of the Gaussian bump. Furthermore, pixels with hue values outside the range of the Gaussian bump retain essentially the same pixel value even with the changed shape of the hue curve, and thus these pixels display the same grayscale shading.

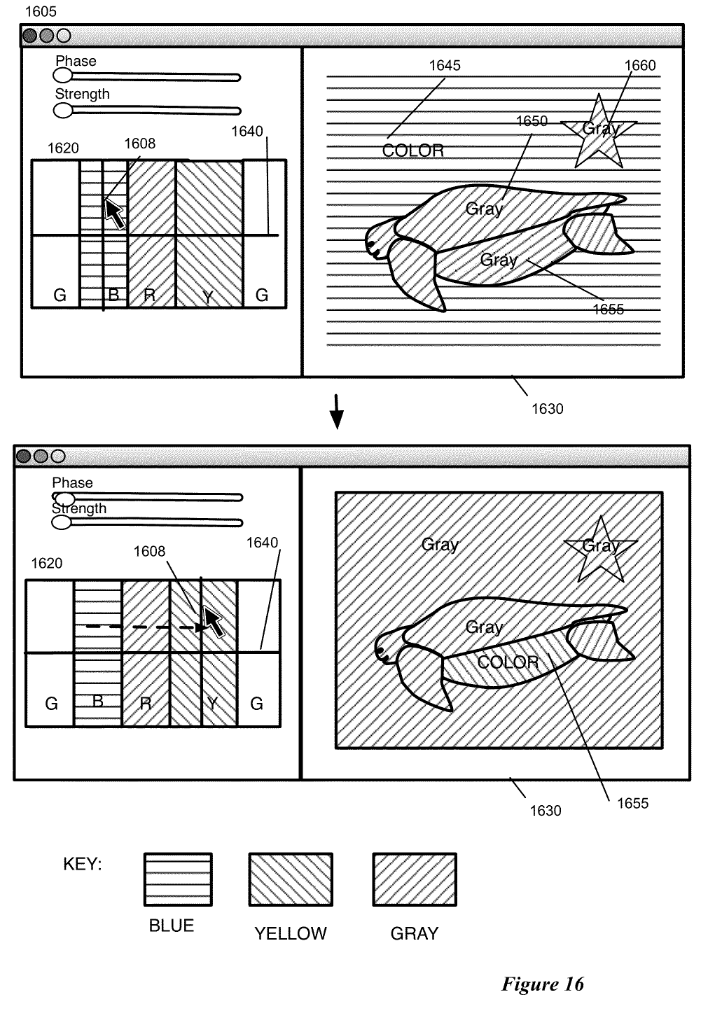

In addition to providing the user with multiple different mechanisms for modifying the grayscale image (e.g., on-screen controls, slider controls, and direct curve manipulation), the image editing application in some embodiments also provides certain other tools that assist the user with the image editing process. In particular, oftentimes after a color image is converted to a grayscale image, it may be difficult to recall the original colors of the different shades of gray within the grayscale image. FIG. 16 illustrates that the image editing application in some embodiments displays, in color, the areas of the image that will be modified when the user modifies the hue curve. In particular, FIG. 16 illustrates in two stages 1605-1610 the user's cursor 1608 hovering over the hue control 1620 and the corresponding color pixels being displayed within the grayscale image by the image editing application.

Stage 1605 illustrates the image editing application displaying the image of the swimming turtle within the image display area 1630. This image has been converted to a grayscale image with a same shading of gray (diagonal lines pointed up) used for all the different colors for simplicity purposes. However, the original color image depicted four colors, corresponding to the blue water 1645, green shell 1650, yellow underbelly 1655, and red starfish 1660. Stage 1605 further illustrates that the user's cursor 1608 is positioned over the hue control 1620. In particular, the cursor 1608 is hovering over a blue portion of the hue color range. As such, the image editing application is displaying the corresponding blue pixels, primarily within the blue water 1645, of the image, in color, within the grayscale image in the image display area 1620. As such, the image of the swimming turtle is displayed primarily in grayscale with only certain areas being displayed in the actual original color, depending on the particular position of the cursor 1608 over the hue control 1620. This allows the user to see the original colors of the grayscale image that will be affected by a modification to the hue curve. The user may hover the cursor 1608 over different areas of the hue color range within the hue control 1620. Thus, a user will know exactly which pixels will be modified if the user adjusts the hue curve 1640 over a particular portion of the hue color spectrum.

In stage 1610, the user has moved the cursor 1608 to hover over a new position within the hue control 1620 that lies primarily above the yellow hue values of the hue color range. Accordingly, the image display area 1630 now displays the yellow underbelly 1655, in color, to provide the user with an indication of the set of pixels that will be affected if the user is to modify the hue curve 1640 at that particular hue value along the hue color spectrum. The rest of the image is still displayed with only shades of gray since pixels with a yellow hue value within this particular image are primarily located within the yellow underbelly 1655.

In order to determine which pixels are displayed as color within the image display area 1630 as a user hovers over the hue control 1620, in some embodiments, the image editing application displays those pixels that would be affected by the Gaussian bump that would be computed for the particular pixel position of the cursor. In particular, the particular width value (w) used in equation (12) would determine that particular range of pixel values that are displayed in color within the image.

### V. Software Architecture

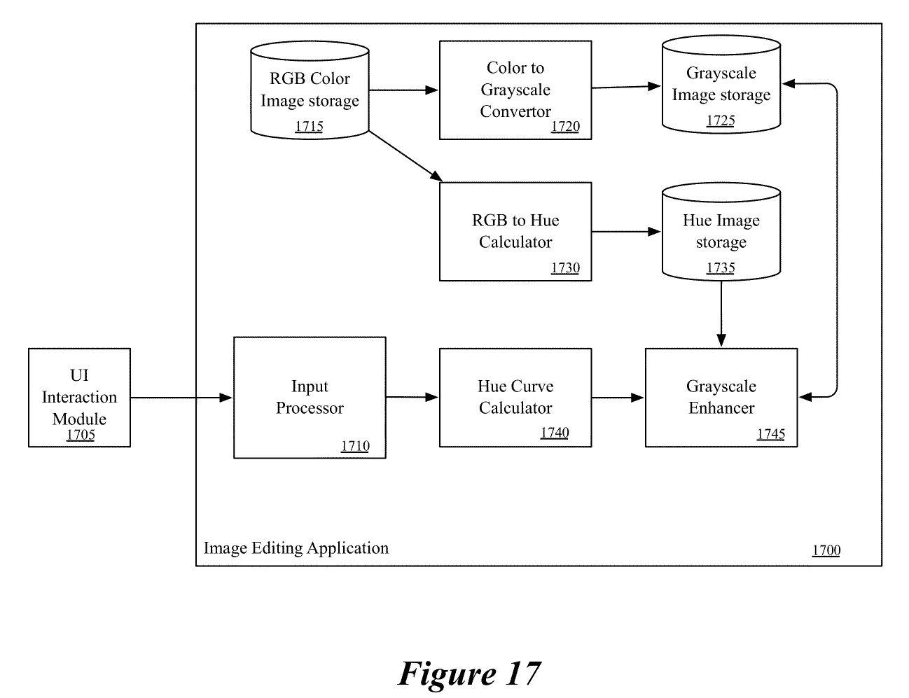

In some embodiments, the processes described above are implemented as software running on a particular machine, such as a computer or a handheld device, or storing in a machine-readable medium. FIG. 17 conceptually illustrates part of the software architecture of an image editing application 1700 of some embodiments. In some embodiments, the image editing application is a stand-alone application or is integrated into another application, while in other embodiments the application might be implemented within an operating system. Furthermore, in some embodiments, the application is provided as part of a server-based solution. In some such embodiments, the application is provided via a thin client. That is, the application runs on a server while a user interacts with the application via a separate machine remote from the server. In other such embodiments, the application is provided via a thick client. That is, the application is distributed from the server to the client machine and runs on the client machine.

The architecture is simplified to represent the portion of the image editing application that performs the grayscale enhancements in some embodiments. FIG. 17 includes image editing application 1700 and UI interaction module 1705. Image editing application 1700 includes Input Processor 1710, Color to Grayscale Convertor 1720, RGB to Hue Calculator 1730, Hue Curve Calculator 1740, and Grayscale Enhancer 1745. Image editing application 1700 also includes various storages, including RGB Color Image storage 1715, Grayscale Image storage 1725, and Hue Image storage 1735.

The UI Interaction Module 1705 receives user input from various different sources. For example, the user input may be received from a touch-screen of the device on which the image editing application 1700 is executing. The user input may also be received from a cursor control tool that detects the movement of a cursor on the screen of the device. Furthermore, various other types of input may be received from different slider controls displayed in a GUI of the imaged editing application.

The Input Processor 1710 receives from the UI Interaction Module 1705 a user's input and computes various values based on this input. The values may include determining a strength value for a grayscale modification to apply to the a grayscale image, a phase value for modifying the phase of a hue curve to be applied to the grayscale image, or input for generating Gaussian bumps along the hue curve.

The Hue Curve Calculator 1740 receives the different values for different variables of the hue curve calculation (e.g., strength, phase, Gaussian, etc.) and calculates the shape of the hue curve based on the received input values. The Grayscale Enhancer 1745 determines gamma values to apply to a grayscale image based on the hue values of the image and the shape of the hue curve as calculated by the Hue Curve Calculator 1740.

The RGB Color Image storage 1715 stores color images that are to be used by the image editing application 1700. The Color to Grayscale Convertor 1720 converts color images into grayscale (black and white) images. The Convertor 1720 may utilize different processes for converting a color image to a grayscale image, including using a standard weighting factors or an “active 3×1” conversion factor. The Color to Grayscale Convertor 1720 then stores the generated grayscale image within the Grayscale Image storage 1725.

The RGB to Hue Calculator 1730 computes hue values for each pixel in a color image based on the R, G, and B values of the color image and stores the hue values in a Hue Image storage 1735. Images within the Hue Image storage 1735 are then analyzed by the Grayscale Enhancer 1745 when modifying pixel values of a grayscale image.

Having described the different modules within the image editing application 1700, an example of a series of operations for enhancing a grayscale image will now be described. The image editing application 1700 initially receives an input from the UI interaction module 1705 that requests a color image to be converted into a grayscale image. Based on this request, the image editing application 1700 initiates the Color to Grayscale Convertor 1720 to convert a color image to a grayscale image. The Color to Grayscale Convertor 1720 retrieves the corresponding color image from the RGB Color Image Storage 1715 and generates a grayscale image based on the RGB values of the color image. In order to generate the grayscale image, the Color to Grayscale Convertor 1720 in some embodiments applies a standard weight conversion mechanism, such as weighting each R value as 30%, each G value as 59%, and each B value as 11%. In some embodiments, based on a user's input, the Color to Grayscale Convertor 1720 converts the color image based on values derived from a single value using an “active 3×1” conversion mechanism, as described above in FIG. 6.

In addition to generating the grayscale image with the Color to Grayscale Convertor 1720, the image editing application 1700 also generates a hue image using the RGB to Hue Calculator 1730 to (i.e., hue mapping of each pixel) for the color image based on the RGB values of each pixel in the image. In order to compute a hue value for each pixel, the RGB to Hue Calculator 1730, of some embodiments, applies the series of computations described above in FIG. 7. In particular, the RGB to Hue Calculator 1730 converts a color image from an RGB to XYS to LMS color space, then compresses the LMS values by raising each L, M, and S value to a particular exponent (e.g., 0.43), then converts from LMS to IPT color space. Finally, the RGB to Hue Calculator 1730 computes a hue value for each pixel in the image by computing, for a particular pixel located at position (x,y) in the image, the arctan 2(T,P).

Having converted the RGB color image to both a grayscale image and a hue image, the image editing application 1700 may now apply hue based enhancements to the grayscale image based on received user input. In particular, upon detecting a user input at the Input Processor 1710 (received from the UI Interaction Module 1705), the Input Processor determines values for the different types of input. In particular, the Input Processor 1710 determines whether the user has modified an amplitude of a function applied to the hue curve. For example, the user may modify the amplitude through various different mechanisms, including: 1) adjust a strength slider, 2) drag the hue curve in a particular direction, or 3) apply an on-screen touch and swipe on a particular pixel of the image. The Input Processor 1710 also determines whether the user has modified a phase of the function applied to the hue curve, through, for example, detecting an adjustment of a phase slider of the user interface. Lastly, the Input Processor 1710 determines whether to add Gaussian bumps to the hue curve, based on, for example, detecting a touch and swipe input directly on certain pixels of the image or through a dragging of the hue curve on a hue control of the user interface.

Based on the computed values for one or more of a: 1) strength, 2) phase, or 3) Gaussian bump, the Input Processor 1710 provides these values to the Hue Curve Calculator 1740. The Hue Curve Calculator 1740 then computes the shape of the hue curve based on the function to the applied to the curve (i.e., sine function). In particular, the calculation of the shape of the hue curve includes the amplitude of the function, the phase of the function, and the Gaussian bumps within the hue range. In some embodiments, the Hue Curve Calculator computes the hue curve using equations (9), (10) and (11) described above. Equation (9) and (10) compute the shape of the hue curve based on the sine function and Equation (11) is used to add Gaussian bumps to the hue curve.

After computing the shape of the hue curve, the Hue Curve Calculator 1740 provides the hue curve to the Grayscale Enhancer 1745. The Grayscale Enhancer then computes gamma values to apply to the grayscale image. In particular, the Grayscale Enhancer 1745 retrieves a particular hue value of a pixel in the hue image. Based on this hue value, the Grayscale Enhancer 1745 examines the shape of the hue curve and the point along the curve that corresponds to the particular hue value, which determines an initial gamma value for the corresponding pixel in the grayscale image. The Grayscale Enhancer 1745, of some embodiments, then normalizes this gamma value to a value in a [0 to 2] range (with a value of 1 corresponding to no modification). The Grayscale Enhancer 1745, of some embodiments, than applies equation (12) to determine the actual gamma exponent value to apply to the grayscale pixel. After computing the exponent gamma value, the Grayscale Enhancer 1745 modifies the particular pixel in the grayscale image and stores, after all the pixels have been modified, the grayscale image in the Grayscale Image Storage 1725. In some embodiments, the Image Editing Application 1700 also displays the enhanced grayscale image on a display of the device.

The software architecture diagram of FIG. 17 is provided to conceptually illustrate some embodiments. One of ordinary skill in the art will realize that some embodiments use different modular setups that may combine multiple functions into one module though the figure shows multiple modules, and/or may split up functions that the figure ascribes to a single module into multiple modules.

### VI. Image Viewing, Editing, and Organization Application

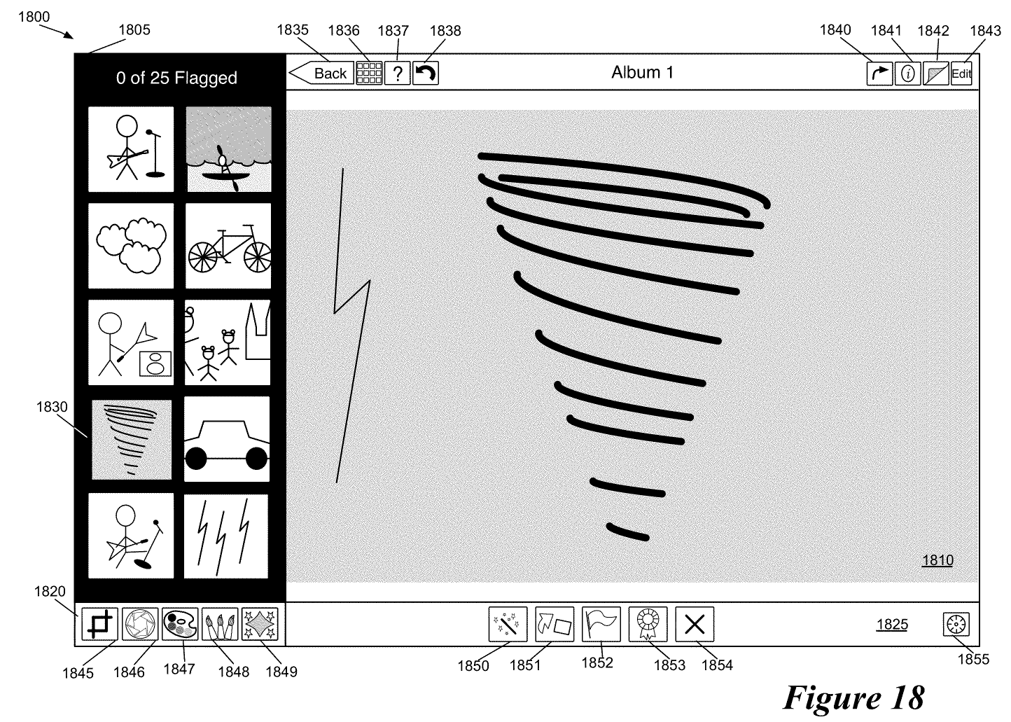

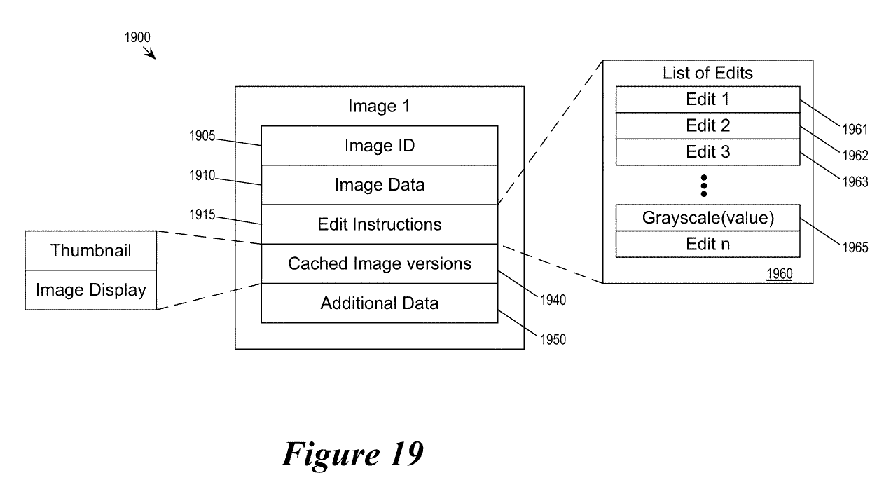

The above-described figures illustrated various examples of the GUI of an image viewing, editing, and organization application of some embodiments. FIG. 18 illustrates a detailed view of a GUI 1800 of some embodiments for viewing, editing, and organizing images. The GUI 1800 will be described in part by reference to FIG. 19, which conceptually illustrates a data structure 1900 for an image as stored by the application of some embodiments.

The data structure 1900 includes an image ID 1905, image data 1910, edit instructions 1915, cached versions 1940 of the image, and any additional data 1950 for the image. The image ID 1905 is a unique identifier for the image, which in some embodiments is used by the collection data structures to refer to the images stored in the collection.

The image data 1910 is the actual full-size pixel data for displaying the image (e.g., a series of color-space channel values for each pixel in the image or an encoded version thereof). In some embodiments, this data may be stored in a database of the image viewing, editing, and organization application, or may be stored with the data of another application on the same device. In some embodiments, this additional application is another image organization application that operates on the device, on top of which the image viewing, editing, and organization operates.

Thus, the data structure may store a pointer to the local file associated with the application or an ID that can be used to query the database of another application. In some embodiments, once the application uses the image in a journal or makes an edit to the image, the application automatically makes a local copy of the image file that contains the image data.

The edit instructions 1915 include information regarding any edits the user has applied to the image. In this manner, the application stores the image in a non-destructive format, such that the application can easily revert from an edited version of the image to the original at any time. For instance, the user can apply a grayscale effect to the image, leave the application, and then reopen the application and remove the effect at another time. The edits stored in these instructions may be crops and rotations, full-image exposure and color adjustments, localized adjustments, and special effects, as well as other edits that affect the pixels of the image. Some embodiments store these editing instructions in a particular order, so that users can view different versions of the image with only certain sets of edits applied.

In some embodiments, the edit instructions 1915 are implemented as a list 1960 of edit operations. The list 1960 includes edit operations such as edits 1961, 1962, 1963, and 1965. Each edit operation in the list 1960 specifies the necessary parameters for carrying out the edit operation. For example, the edit operation 1965 in the list 1960 specifies an edit to the image that applies a grayscale enhancement with a particular value to the image.

In some embodiments, the list 1960 records the sequence of edit operations undertaken by the user in order to create the final edited image. In some embodiments, the list 1960 stores the edit instructions in the order that the image editing application applies the edits to the image in order to generate an output image for display, as some embodiments define a particular order for the different possible edits provided by the application. For example, some embodiments define the grayscale effect as one of the edit operations that are to be applied later than other edit operations such as crop and rotation, full-image exposure, and color adjustment. The list 1960 of some of these embodiments would store the edit instruction for grayscale enhancement effect in a position (i.e., edit 1965) that would be applied later than some of the other edit operations (e.g., edits 1961-1963).

The cached image versions 1940 store versions of the image that are commonly accessed and displayed, so that the application does not need to repeatedly generate these images from the full-size image data 1910. For instance, the application will often store a thumbnail for the image as well as a display resolution version (e.g., a version tailored for the image display area). The application of some embodiments generates a new thumbnail for an image each time an edit is applied, replacing the previous thumbnail. Some embodiments store multiple display resolution versions including the original image and one or more edited versions of the image. In some embodiments, the saturation thumbnails in the slider 205 are generated off the cached thumbnail image. Finally, the image data structure 1900 includes additional data 1950 that the application might store with an image (e.g., locations and sizes of faces, etc.). In some embodiments, the additional data can include Exchangeable image file format (Exif) data, caption data, shared image data, tags on the image or any other types of data. Exif data includes various information stored by the camera that are captured the image such as camera settings, GPS data, timestamps, etc. Caption is a user-entered description of the image. Tags are information that the application enables the user to associate with an image such as marking the image as a favorite, flagged, hidden, etc.

One of ordinary skill in the art will recognize that the image data structure 1900 is only one possible data structure that the application might use to store the required information for an image. For example, different embodiments might store additional or less information, store the information in a different order, etc.

Returning to FIG. 18, the GUI 1800 includes a thumbnail display area 1805, an image display area 1810, a first toolbar 1815, a second toolbar 1820, and a third toolbar 1825. The thumbnail display area 1805 displays thumbnails of the images in a selected collection. Thumbnails are small representations of a full-size image, and represent only a portion of an image in some embodiments. For example, the thumbnails in thumbnail display area 1805 are all squares, irrespective of the aspect ratio of the full-size images. In order to determine the portion of a rectangular image to use for a thumbnail, the application identifies the smaller dimension of the image and uses the center portion of the image in the longer direction. For instance, with a 1600×1200 pixel image, the application would use a 1200×1200 square. To further refine the selected portion for a thumbnail, some embodiments identify a center of all the faces in the image (using a face detection algorithm), then use this location to center the thumbnail portion in the clipped direction. Thus, if the faces in the theoretical 1600×1200 image were all located on the left side of the image, the application would use the leftmost 1200 columns of pixels rather than cut off 200 columns on either side.

After determining the portion of the image to use for the thumbnail, the image-viewing application generates a low resolution version (e.g., using pixel blending and other techniques) of the image. The application of some embodiments stores the thumbnail for an image as a cached version 1940 of the image. Thus, when a user selects a collection, the application identifies all of the images in the collection (through the collection data structure), and accesses the cached thumbnails in each image data structure for display in the thumbnail display area.

The user may select one or more images in the thumbnail display area (e.g., through various touch interactions described above or through other user input interactions). The selected thumbnails are displayed with a highlight or other indicator of selection. In thumbnail display area 1805, the thumbnail 1830 is selected. In addition, as shown, the thumbnail display area 1805 of some embodiments indicates a number of images in the collection that have been flagged (e.g., having a tag for the flag set to yes). In some embodiments, this text is selectable in order to display only the thumbnails of the flagged images.

The application displays selected images in the image display area 1810 at a larger resolution than the corresponding thumbnails. The images are not typically displayed at the full size of the image, as images often have a higher resolution than the display device. As such, the application of some embodiments stores a cached version 1940 of the image designed to fit into the image display area. Images in the image display area 1810 are displayed in the aspect ratio of the full-size image. When one image is selected, the application displays the image as large as possible within the image display area without cutting off any part of the image. When multiple images are selected, the application displays the images in such a way as to maintain their visual weighting by using approximately the same number of pixels for each image, even when the images have different aspect ratios.

The first toolbar 1815 displays title information (e.g., the name of the collection shown in the GUI, a caption that a user has added to the currently selected image, etc.). In addition, the toolbar 1815 includes a first set of GUI items 1835-1838 and a second set of GUI items 1840-1843.

The first set of GUI items includes a back button 1835, a grid button 1836, a help button 1837, and an undo button 1838. The back button 1835 enables the user to navigate back to a collection organization GUI, from which users can select between different collections of images (e.g., albums, events, journals, etc.). Selection of the grid button 1836 causes the application to move the thumbnail display area on or off of the GUI (e.g., via a slide animation). In some embodiments, users can also slide the thumbnail display area on or off of the GUI via a swipe gesture. The help button 1837 activates a context-sensitive help feature that identifies a current set of tools active for the user and provides help indicators for those tools that succinctly describe the tools to the user. In some embodiments, the help indicators are selectable to access additional information about the tools. Selection of the undo button 1838 causes the application to remove the most recent edit to the image, whether this edit is a crop, color adjustment, etc. In order to perform this undo, some embodiments remove the most recent instruction from the set of edit instructions 1915 stored with the image.

The second set of GUI items includes a sharing button 1840, an information button 1841, a show original button 1842, and an edit button 1843. The sharing button 1840 enables a user to share an image in a variety of different ways. In some embodiments, the user can send a selected image to another compatible device on the same network (e.g., WiFi or Bluetooth network), upload an image to an image hosting or social media website, and create a journal (i.e., a presentation of arranged images to which additional content can be added) from a set of selected images, among others.

The information button 1841 activates a display area that displays additional information about one or more selected images. The information displayed in the activated display area may include some or all of the Exif data 1925 stored for an image (e.g., camera settings, timestamp, etc.). When multiple images are selected, some embodiments only display Exif data that is common to all of the selected images. Some embodiments include additional tabs within the information display area for (i) displaying a map showing where the image or images were captured according to the GPS data, if this information is available and (ii) displaying comment streams for the image on any photo sharing websites. To download this information from the websites, the application uses the object ID stored for the image with the shared image data 1935 and sends this information to the website. The comment stream and, in some cases, additional information, are received from the website and displayed to the user.

The show original button 1842 enables the user to toggle between the original version of an image and the current edited version of the image. When a user selects the button, the application displays the original version of the image without any of the editing instructions 1915 applied. In some embodiments, the appropriate size image is stored as one of the cached versions 1940 of the image, making it quickly accessible. When the user selects the button again 1842 again, the application displays the edited version of the image, with the editing instructions 1915 applied.

The edit button 1843 allows the user to enter or exit edit mode. When a user has selected one of the sets of editing tools in the toolbar 1820, the edit button 1843 returns the user to the viewing and organization mode, as shown in FIG. 18. When the user selects the edit button 1843 while in the viewing mode, the application returns to the last used set of editing tools in the order shown in toolbar 1820. That is, the items in the toolbar 1820 are arranged in a particular order, and the edit button 1843 activates the rightmost of those items for which edits have been made to the selected image.

The toolbar 1820, as mentioned, includes five items 1845-1849, arranged in a particular order from left to right. The crop item 1845 activates a cropping and rotation tool that allows the user to align crooked images and remove unwanted portions of an image. The exposure item 1846 activates a set of exposure tools that allow the user to modify the black point, shadows, contrast, brightness, highlights, and white point of an image. In some embodiments, the set of exposure tools is a set of sliders that work together in different combinations to modify the tonal attributes of an image. The color item 1847 activates a set of color tools that enable the user to modify the saturation and vibrancy, as well as color-specific saturations (e.g., blue pixels or green pixels) and white balance. In some embodiments, some of these tools are presented as a set of sliders. The brushes item 1848 activates a set of enhancement tools that enable a user to localize modifications to the image. With the brushes, the user can remove red-eye and blemishes, and apply or remove saturation and other features to localized portions of an image by performing a rubbing action over the image. Finally, the effects item 1849 activates a set of special effects that the user can apply to the image. These effects include duotone effect, grainy effect, gradients, tilt shifts, non-photorealistic desaturation effects, grayscale effects, various filters, etc. In some embodiments, the application presents these effects as a set of items that fan out from the toolbar 1825.

As stated, the UI items 1845-1849 are arranged in a particular order. This order follows the order in which users most commonly apply the five different types of edits. Accordingly, the editing instructions 1915 are stored in this same order, in some embodiments. When a user selects one of the items 1845-1849, some embodiments apply only the edits from the tools to the left of the selected tool to the displayed image (though other edits remain stored within the instruction set 1915).

The toolbar 1825 includes a set of GUI items 1850-1854 as well as a settings item 1855. The auto-enhance item 1850 automatically performs enhancement edits to an image (e.g., removing apparent red-eye, balancing color, etc.). The rotation button 1851 rotates any selected images. In some embodiments, each time the rotation button is pressed, the image rotates 90 degrees in a particular direction. The auto-enhancement, in some embodiments, comprises a predetermined set of edit instructions that are placed in the instruction set 1915. Some embodiments perform an analysis of the image and then define a set of instructions based on the analysis. For instance, the auto-enhance tool will attempt to detect red-eye in the image, but if no red-eye is detected then no instructions will be generated to correct it. Similarly, automatic color balancing will be based on an analysis of the image. The rotations generated by the rotation button are also stored as edit instructions.

The flag button 1852 tags any selected image as flagged. In some embodiments, the flagged images of a collection can be displayed without any of the unflagged images. The favorites button 1853 allows a user to mark any selected images as favorites. In some embodiments, this tags the image as a favorite and also adds the image to a collection of favorite images. The hide button 1854 enables a user to tag an image as hidden. In some embodiments, a hidden image will not be displayed in the thumbnail display area and/or will not be displayed when a user cycles through the images of a collection in the image display area. As discussed above by reference to FIG. 19, many of these features are stored as tags in the image data structure.

Finally, the settings button 1855 activates a context-sensitive menu that provides different menu options depending on the currently active toolset. For instance, in viewing mode the menu of some embodiments provides options for creating a new album, setting a key photo for an album, copying settings from one photo to another, and other options. When different sets of editing tools are active, the menu provides options related to the particular active toolset.

One of ordinary skill in the art will recognize that the image viewing and editing GUI 1800 is only one example of many possible graphical user interfaces for an image viewing, editing, and organizing application. For instance, the various items could be located in different areas or in a different order, and some embodiments might include items with additional or different functionalities. The thumbnail display area of some embodiments might display thumbnails that match the aspect ratio of their corresponding full-size images, etc.

### VII. Electronic Systems

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random access memory (RAM) chips, hard drives, erasable programmable read-only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

A. Mobile Device

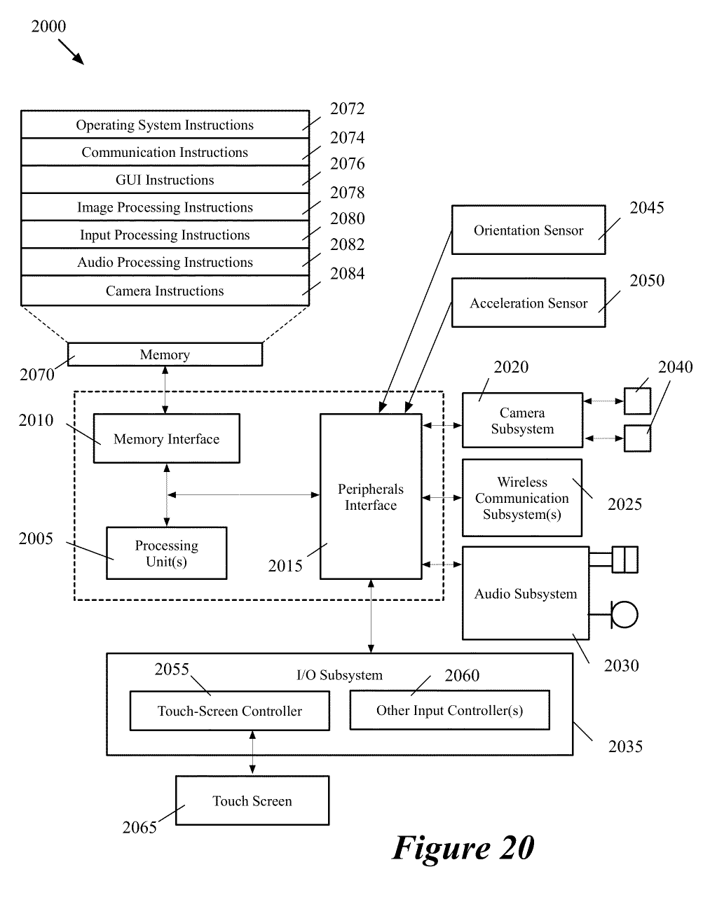

The image editing and viewing applications of some embodiments operate on mobile devices. FIG. 20 is an example of an architecture 2000 of such a mobile computing device. Examples of mobile computing devices include smartphones, tablets, laptops, etc. As shown, the mobile computing device 2000 includes one or more processing units 2005, a memory interface 2010 and a peripherals interface 2015.

The peripherals interface 2015 is coupled to various sensors and subsystems, including a camera subsystem 2020, a wireless communication subsystem(s) 2025, an audio subsystem 2030, an I/O subsystem 2035, etc. The peripherals interface 2015 enables communication between the processing units 2005 and various peripherals. For example, an orientation sensor 2045 (e.g., a gyroscope) and an acceleration sensor 2050 (e.g., an accelerometer) is coupled to the peripherals interface 2015 to facilitate orientation and acceleration functions.

The camera subsystem 2020 is coupled to one or more optical sensors 2040 (e.g., a charged coupled device (CCD) optical sensor, a complementary metal-oxide-semiconductor (CMOS) optical sensor, etc.). The camera subsystem 2020 coupled with the optical sensors 2040 facilitates camera functions, such as image and/or video data capturing. The wireless communication subsystem 2025 serves to facilitate communication functions. In some embodiments, the wireless communication subsystem 2025 includes radio frequency receivers and transmitters, and optical receivers and transmitters (not shown in FIG. 20). These receivers and transmitters of some embodiments are implemented to operate over one or more communication networks such as a GSM network, a Wi-Fi network, a Bluetooth network, etc. The audio subsystem 2030 is coupled to a speaker to output audio (e.g., to output different sound effects associated with different image operations). Additionally, the audio subsystem 2030 is coupled to a microphone to facilitate voice-enabled functions, such as voice recognition, digital recording, etc.

The I/O subsystem 2035 involves the transfer between input/output peripheral devices, such as a display, a touch screen, etc., and the data bus of the processing units 2005 through the peripherals interface 2015. The I/O subsystem 2035 includes a touch-screen controller 2055 and other input controllers 2060 to facilitate the transfer between input/output peripheral devices and the data bus of the processing units 2005. As shown, the touch-screen controller 2055 is coupled to a touch screen 2065. The touch-screen controller 2055 detects contact and movement on the touch screen 2065 using any of multiple touch sensitivity technologies. The other input controllers 2060 are coupled to other input/control devices, such as one or more buttons. Some embodiments include a near-touch sensitive screen and a corresponding controller that can detect near-touch interactions instead of or in addition to touch interactions.

The memory interface 2010 is coupled to memory 2070. In some embodiments, the memory 2070 includes volatile memory (e.g., high-speed random access memory), non-volatile memory (e.g., flash memory), a combination of volatile and non-volatile memory, and/or any other type of memory. As illustrated in FIG. 20, the memory 2070 stores an operating system (OS) 2072. The OS 2072 includes instructions for handling basic system services and for performing hardware dependent tasks.

The memory 2070 also includes communication instructions 2074 to facilitate communicating with one or more additional devices; graphical user interface instructions 2076 to facilitate graphic user interface processing; image processing instructions 2078 to facilitate image-related processing and functions; input processing instructions 2080 to facilitate input-related (e.g., touch input) processes and functions; audio processing instructions 2082 to facilitate audio-related processes and functions; and camera instructions 2084 to facilitate camera-related processes and functions. The instructions described above are merely exemplary and the memory 2070 includes additional and/or other instructions in some embodiments. For instance, the memory for a smartphone may include phone instructions to facilitate phone-related processes and functions. The above-identified instructions need not be implemented as separate software programs or modules. Various functions of the mobile computing device can be implemented in hardware and/or in software, including in one or more signal processing and/or application specific integrated circuits.

While the components illustrated in FIG. 20 are shown as separate components, one of ordinary skill in the art will recognize that two or more components may be integrated into one or more integrated circuits. In addition, two or more components may be coupled together by one or more communication buses or signal lines. Also, while many of the functions have been described as being performed by one component, one of ordinary skill in the art will realize that the functions described with respect to FIG. 20 may be split into two or more integrated circuits.

B. Computer System

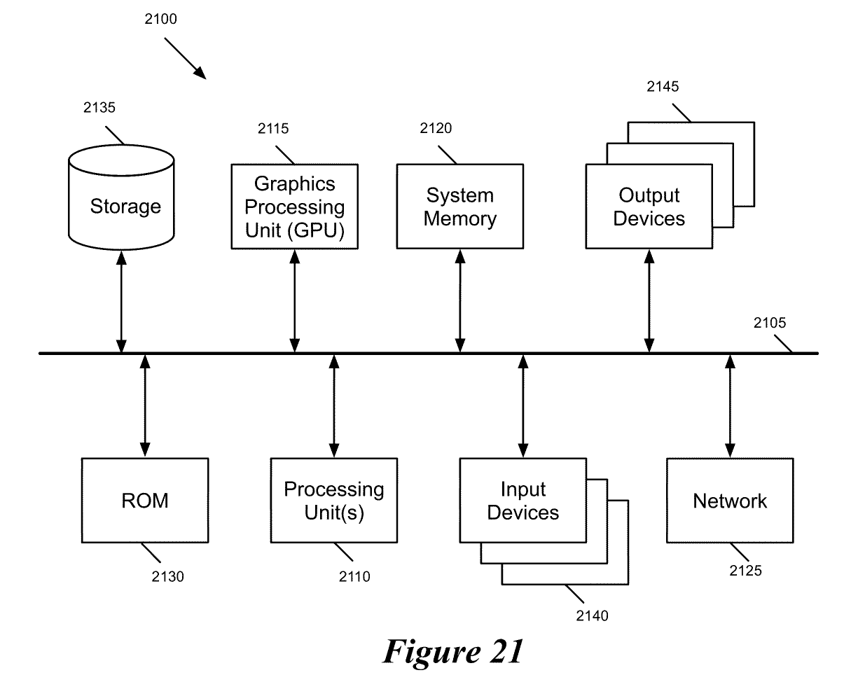

FIG. 21 conceptually illustrates another example of an electronic system 2100 with which some embodiments of the invention are implemented. The electronic system 2100 may be a computer (e.g., a desktop computer, personal computer, tablet computer, etc.), phone, PDA, or any other sort of electronic or computing device. Such an electronic system includes various types of computer readable media and interfaces for various other types of computer readable media. Electronic system 2100 includes a bus 2105, processing unit(s) 2110, a graphics processing unit (GPU) 2115, a system memory 2120, a network 2125, a read-only memory 2130, a permanent storage device 2135, input devices 2140, and output devices 2145.

The bus 2105 collectively represents all system, peripheral, and chipset buses that communicatively connect the numerous internal devices of the electronic system 2100. For instance, the bus 2105 communicatively connects the processing unit(s) 2110 with the read-only memory 2130, the GPU 2115, the system memory 2120, and the permanent storage device 2135.

From these various memory units, the processing unit(s) 2110 retrieves instructions to execute and data to process in order to execute the processes of the invention. The processing unit(s) may be a single processor or a multi-core processor in different embodiments. Some instructions are passed to and executed by the GPU 2115. The GPU 2115 can offload various computations or complement the image processing provided by the processing unit(s) 2110. In some embodiments, such functionality can be provided using CoreImage's kernel shading language.

The read-only-memory (ROM) 2130 stores static data and instructions that are needed by the processing unit(s) 2110 and other modules of the electronic system. The permanent storage device 2135, on the other hand, is a read-and-write memory device. This device is a non-volatile memory unit that stores instructions and data even when the electronic system 2100 is off. Some embodiments of the invention use a mass-storage device (such as a magnetic or optical disk and its corresponding disk drive) as the permanent storage device 2135.

Other embodiments use a removable storage device (such as a floppy disk, flash memory device, etc., and its corresponding drive) as the permanent storage device. Like the permanent storage device 2135, the system memory 2120 is a read-and-write memory device. However, unlike storage device 2135, the system memory 2120 is a volatile read-and-write memory, such a random access memory. The system memory 2120 stores some of the instructions and data that the processor needs at runtime. In some embodiments, the invention's processes are stored in the system memory 2120, the permanent storage device 2135, and/or the read-only memory 2130. For example, the various memory units include instructions for processing multimedia clips in accordance with some embodiments. From these various memory units, the processing unit(s) 2110 retrieves instructions to execute and data to process in order to execute the processes of some embodiments.

The bus 2105 also connects to the input and output devices 2140 and 2145. The input devices 2140 enable the user to communicate information and select commands to the electronic system. The input devices 2140 include alphanumeric keyboards and pointing devices (also called “cursor control devices”), cameras (e.g., webcams), microphones or similar devices for receiving voice commands, etc. The output devices 2145 display images generated by the electronic system or otherwise output data. The output devices 2145 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 21, bus 2105 also couples electronic system 2100 to a network 2125 through a network adapter (not shown). In this manner, the computer can be a part of a network of computers (such as a local area network (“LAN”), a wide area network (“WAN”), or an Intranet, or a network of networks, such as the Internet. Any or all components of electronic system 2100 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the invention has been described with reference to numerous specific details, one of ordinary skill in the art will recognize that the invention can be embodied in other specific forms without departing from the spirit of the invention. For instance, many of the figures illustrate various touch gestures (e.g., taps, double taps, swipe gestures, press and hold gestures, etc.). However, many of the illustrated operations could be performed via different touch gestures (e.g., a swipe instead of a tap, etc.) or by non-touch input (e.g., using a cursor controller, a keyboard, a touchpad/trackpad, a near-touch sensitive screen, etc.). In addition, a number of the figures (including FIGS. 2, 7, and 9) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process.

In view of the foregoing, one of ordinary skill in the art would understand that the invention is not to be limited by the foregoing illustrative details, but rather is to be defined by the appended claims.

What is claimed is:

1. A method of generating a grayscale image, the method comprising:
generating an initial grayscale image based on a color image;
generating a set of values based on the color image;
defining a curve that spans across a range of values through a user interface control; and
modifying the grayscale image based on the set of values and the curve.

2. The method of claim 1, wherein the curve is a hue curve that is defined across a range of hue values in a hue color space and the set of values are hue values, wherein the hue curve defines a gamma value for each hue value in the range of hue values in the hue color space.

3. The method of claim 2 further comprising normalizing values of the hue curve to generate the gamma values before modifying the grayscale image.

4. The method of claim 2, wherein the set of hue values comprises a hue value for each pixel in the color image, wherein modifying the grayscale image comprises, for each pixel in the grayscale image, applying the gamma value defined for the hue value of the pixel in the color image to a corresponding pixel in the grayscale image.

5. The method of claim 1, where the curve is a sine wave through a hue color space.

6. The method of claim 1, wherein generating the initial grayscale image comprises, for each of a plurality of pixels in the color image:
multiplying a first grayscale weighting value by a first color component value of the pixel;
multiplying a second grayscale weighting value by a second color component value of the pixel;
multiplying a third grayscale weighting value by a third color component value of the pixel; and
adding together the results of the multiplying to determine the initial grayscale value for a corresponding pixel in the grayscale image.

7. The method of claim 1, wherein generating the initial grayscale image comprises receiving a single value through a user interface control, computing a plurality of different grayscale weighting values based on the single value, and generating the grayscale image by applying the plurality of different grayscale weighting values to the color image.

8. The method of claim 1, wherein the user interface control comprises a slider for modifying a shape of the curve.

9. The method of claim 8, wherein the slider is a strength slider that modifies the amplitude of a function imposed on the curve.

10. The method of claim 8, wherein the slider is a phase slider that modifies the phase of a function imposed on the curve.

11. The method of claim 1, wherein the curve is deformable and directly modified based on input received directly on the curve from the user interface control.

12. The method of claim 11, wherein the deformable curve is modified based on a Gaussian distribution.

13. A non-transitory machine readable medium storing a program which when executed by at least one processing unit generates a grayscale image, the program comprising sets of instructions for:
generating an initial grayscale image based on a color image;
generating a plurality of hue values based on the color image;
defining a hue curve through a user interface control;
computing a plurality of exponent values to be applied to the grayscale image based on the plurality of hue values of the color image and the hue curve; and
applying the plurality of exponent values to the grayscale image to generate an enhanced grayscale image.

14. The non-transitory machine readable medium of claim 13, wherein the set of instructions for defining the hue curve comprises a set of instructions for computing a gamma value for each hue value in a range of hue values in a hue color space.

15. The non-transitory machine readable medium of claim 14 further comprising a set of instructions for normalizing values of the hue curve to generate the gamma values before modifying the grayscale image.

16. The non-transitory machine readable medium of claim 14, wherein the set of hue values comprises a hue value for each pixel in the color image, wherein the set of instructions for modifying the grayscale image comprises a set of instructions for applying, for each pixel in the grayscale image, the gamma value defined for the hue value of the pixel in the color image to a corresponding pixel in the grayscale image.

17. The non-transitory machine readable medium of claim 16, wherein the set of instructions for applying the gamma value comprises a set of instructions for raising a luminance value of the pixel to the power of the gamma value.

18. A method for modifying a grayscale image based on attributes of a color image corresponding to the grayscale image, the method comprising:
providing a first display area for displaying the grayscale image;
providing a second display area for displaying a modifiable graph correlating attributes of the color image to gamma modification values to apply to the grayscale image;
providing graph adjustment tools for modifying a shape of the graph, wherein the shape of the graph determines gamma values to apply to pixels in the grayscale image.

19. The method of claim 18, wherein the attributes comprise hue values of pixels in the color image computed based on R, G, B values of the pixels.

20. The method of claim 19, wherein the method applies, for each pixel in the grayscale image, the gamma value defined for the hue value of the pixel in the color image to a corresponding pixel in the grayscale image.
